(19) United States
(12) Patent Application Publication
(10) Pub. No.: US 2013/0344473 A1
(43) Pub. Date: Dec. 26, 2013

(54) ARRESTING OBJECTS

(71) Applicants: Mordechai Deutsch, Moshav Olesh (IL); Yana Shafran, Petach-Tikva (IL); Sergei Moshkov, Petach-Tikva (IL)

(72) Inventors: Mordechai Deutsch, Moshav Olesh (IL); Yana Shafran, Petach-Tikva (IL); Sergei Moshkov, Petach-Tikva (IL)

(73) Assignee: Seng Enterprises Ltd., Larnaca (CY)

(21) Appl. No.: 14/003,890

(22) PCT Filed: Mar. 7, 2012
(86) PCT No.: PCT/IL2012/050077

§ 371 Date: Sep. 9, 2013

Related U.S. Application Data
(60) Provisional application No. 61/450,660, filed on Mar. 9, 2011.
(60) Provisional application No. 61/501,326, filed on Jun. 27, 2011.

(51) Int. Cl. A01N 1/02

(52) U.S. Cl. CPC A01N 1/0221
USPC 435/2; 435/307.1

(57) ABSTRACT

A method and system for arresting objects in an array of chambers including, applying a solution to at least one chamber in an array of chambers, in a manner that does not connect two chambers, such that at least one object in the solution is arrested in said at least one chamber, the chambers having a volume of 0.5 microliters-3 microliters.

### RELATED APPLICATIONS

This is a PCT application which claims the benefit of priority of U.S. Provisional Patent Applications No. 61/450,660 filed Mar. 9, 2011, and No. 61/501,326 filed Jun. 27, 2011 the contents of which are incorporated herein by reference in their entirety.

### FIELD AND BACKGROUND OF THE INVENTION

The present invention, in some embodiments thereof, relates to an array of chambers, and, more particularly, but not exclusively, to an apparatus and a method for arresting objects such as living cells and/or molecules in the chambers.

WO 2007/098148 discloses “Arrays of single molecules and methods of producing an array of single molecules are described. Arrays with defined volumes between 10 attoliters and 50 picoliters enable single molecule detection and quantitation. Biomolecules such as enzymes can be addressed at the single molecule level in order to discover function, detect binding partners or inhibitors, and/or measure rate constants.”

Lee et al. “Large-scale arrays of picolitre chambers for single-cell analysis of large cell populations.” Lab Chip. 2010 Nov. 7; 10 (21):2952-8. Epub 2010 Sep. 13.

Mei et al. “Protein synthesis in a device with nanoporous membranes and microchannels.” Lab Chip. 2010 Oct. 7; 10 (19):2541-5. Epub 2010 Aug. 23.

Background art includes:

U.S. Pat. No. 7,405,071

United States Application 2005064524

United States Application 2006240548

United States Application 2007292837

United States Application 2008009051

United States Application 2009105095

United States Application 2009111141

WO2009063462

### SUMMARY OF THE INVENTION

An aspect of some embodiments of the invention relates to an apparatus and a method of arresting at least one living cell and/or non-living object (eg. DNA molecules) in at least one chamber.

There is provided in accordance with an exemplary embodiment of the invention, a method of arresting objects in an array of chambers comprising:

applying a solution to at least one chamber in an array of chambers, in a manner that does not connect two chambers, such that at least one object in the solution is arrested in the at least one chamber, the chambers having a volume of 0.5 μL-3 μL.

In an exemplary embodiment of the invention, applying comprises connecting two chambers by the solution, then isolating the two chambers by reducing an amount of the solution. Alternatively or additionally, applying the solution comprises applying the solution to at least one chamber to a level no more than a height of walls of the at least one chamber.

In an exemplary embodiment of the invention, the method further comprises applying a cover to the at least one chamber. Optionally, the cover comprises a fluid floating above the solution. Optionally or additionally, the cover repels water from the chambers.

In an exemplary embodiment of the invention, the method further comprises manipulating or inserting the at least one object into the solution in the at least one chamber through the cover.

In an exemplary embodiment of the invention, the method further comprises applying at least one plug to an opening of the at least one chamber.

In an exemplary embodiment of the invention, the method further comprises removing a volume of the solution from at least one of the chamber or from a space in between at least two adjacent of the at least one chamber. Optionally, removing comprises removing by wicking.

In an exemplary embodiment of the invention, the at least one object comprises a living cell. Optionally, the living cell comprises a sperm cell.

In an exemplary embodiment of the invention, the at least one object comprises a molecule. Optionally, the molecule comprises DNA.

In an exemplary embodiment of the invention, the arrested objects in the solution in the chambers are cryopreserved.

In an exemplary embodiment of the invention, the method further comprises reducing or preventing evaporation of the solution from the at least one chamber.

There is provided in accordance with an exemplary embodiment of the invention, a device for arresting objects in chambers comprising:

at least two chambers; and

a space in between the at least two chambers, the space is large enough to prevent and/or reduce surface tension forces from holding a fluid in the space; and

a support coupled to the chamber.

In an exemplary embodiment of the invention, a volume of the chamber ranges from an attoliter to a milliliter.

There is provided in accordance with an exemplary embodiment of the invention, a device for arresting objects in chambers comprising:

at least one chamber; and

a support attached to the chamber, the support comprising a material to wick an excess of a solution over or around the at least one chamber.

There is provided in accordance with an exemplary embodiment of the invention, a device for arresting objects in an array of chambers comprising:

at least one chamber having a volume of 0.5 μL-3 μL; and

a support attached to the at least one chamber, the support made out of a material having a sufficiently low heat capacity and a sufficiently high thermal conductivity so as to cryopreserve cells in the at least one chamber.

In an exemplary embodiment of the invention, the support is made out of a material transparent to visible light.

There is provided in accordance with an exemplary embodiment of the invention, a system for arresting objects in an array of chambers comprising:

at least one chamber having a volume of 0.5 μL-3 μL with an opening;

at least one plug having a shape that conforms to the opening such that the at least one plug substantially closes the opening without substantially entering the chamber; and

a solution covering the at least one chamber, the at least one plug suspended in the solution.

In an exemplary embodiment of the invention, a density of the plug is relatively higher than a density of the solution, such that the plug sinks into the opening. Alternatively or additionally, the plug contains at least some magnetic material and further comprising a magnet positioned relative to the chamber to attract the plug to the opening. Alternatively or additionally, the plug is coated with a first substance, and the opening is coated with a second substance having an affinity for the first substance.

In an exemplary embodiment of the invention, the plug has a size large enough to cover to or more of the openings, and a shape that conforms at least along a length to two or more of the openings such that the at least one plug substantially seals off two or more of the openings. Optionally, a size of the plug is relatively larger than a size of the opening of the chamber. Alternatively, a diameter of the plug is smaller than a diameter of the opening of the chamber plus the distance between the chambers but larger than a diameter of the chamber. Alternatively, a diameter of the plug is relatively smaller than a diameter of the opening of the chamber.

In an exemplary embodiment of the invention, the plug is comprised of a pliable material, the material sufficiently pliable to seal cracks in between the plug and the opening. Alternatively, the shape of the plug does not fully conform to the opening, thereby leaving gaps between the plug and the opening.

There is provided in accordance with an exemplary embodiment of the invention, a method of arresting objects in an array of chambers comprising:

applying a solution having suspended objects therein to an array of chambers;

covering the chamber; and

removing a volume of the solution from at least one of above and around the chambers such that the cover rests over the chambers and the chambers are filled with the solution.

There is provided in accordance with an exemplary embodiment of the invention, a method of arresting objects in an array of chambers comprising:

applying a fluid or a film to an array of chambers; and

inserting a solution into at least one chamber of the array, through the fluid or the film, wherein the solution comprises at least one object.

There is provided in accordance with an exemplary embodiment of the invention, a method of arresting objects in an array of chambers comprising:

applying a solution having suspended objects therein to an array of chambers; and

plugging at least one chamber with at least one plug.

There is provided in accordance with an exemplary embodiment of the invention, a device for arresting objects comprising:

a chamber having a volume between 0.5 and 3 microliters;

a support attached to the chamber; and

In an exemplary embodiment of the invention, the device further comprises a plurality of chambers having a volume of no more than 3 microliters per chamber, the chambers attached to the support.

In an exemplary embodiment of the invention, the chambers are separated from one another by a gap, the gap is defined as a space surrounding at least some portion of a height of walls of the chambers above the support.

In an exemplary embodiment of the invention, the chamber is a hollow cylinder. In an exemplary embodiment of the invention, at least a portion of an inner surface of the chamber is at least one of made from and coated with a hydrophobic coating.

In an exemplary embodiment of the invention, the device further comprising one or more elevations in the support of the chamber, the elevations arranged to prevent a suspension from contacting walls of the chambers.

There is provided in accordance with an exemplary embodiment of the invention, a method of arresting at least one object comprising:

providing a suspension containing the objects, the suspension having a volume of no more than 3 microliters;

inserting the suspension into a chamber having a volume of 0.5-3 microliters; and

applying a cover to the chamber to arrest the object therein.

In an exemplary embodiment of the invention, inserting comprises inserting the suspension into separate chambers without leakage that forms fluid communication between the chambers.

In an exemplary embodiment of the invention, the method further comprises cryopreserving the arrested object and the chamber.

In an exemplary embodiment of the invention, the method further comprises selecting the chamber according to desired freezing speed.

There is provided in accordance with an exemplary embodiment of the invention, a method of arresting one or more objects in an array of chambers comprising:

applying a fluid or a film to an array of chambers, the chambers having a volume of 0.5-3 microliters; and

inserting the object having a diameter of over 250 μm into a fluid contained within at least one chamber of the array, the object arrested by a cover disposed above the fluid.

In an exemplary embodiment of the invention, inserting the object comprises inserting the object through the cover into the fluid.

There is provided in accordance with an exemplary embodiment of the invention, a liquid array comprising:

two or more chambers, each of the chambers, each of the chambers having a volume between an attoliter to a milliliter, each of the chambers filled with a liquid;

a support attached to the chambers, the chambers arranged on the support to be separated by a gap of air.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings and/or images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is an illustration of an array of chambers, as used in some embodiments of the invention;

FIG. 1B is an illustration of the chamber array, in accordance with an exemplary embodiment of the invention;

FIG. 1C is a flowchart of a method of arresting cells and/or objects in chambers, in accordance with an exemplary embodiment of the invention;

FIG. 2A is a flowchart of a method of arresting objects, in accordance with an exemplary embodiment of the invention;

FIGS. 2B-2C illustrate an alternative apparatus for arresting objects in chambers, for example, using the method of FIG. 2A, in accordance with some embodiments of the invention;

FIGS. 2D-2G illustrate an alternative system for arresting objects in chambers, for example, using the method of FIG. 2A, in accordance with some embodiments of the invention;

FIGS. 3A-3D are images illustrating the method of FIG. 2, in accordance with an exemplary embodiment of the invention;

FIG. 4 is an illustration of cells arrested using the method of FIG. 2, in accordance with an exemplary embodiment of the invention;

FIG. 5 is a flowchart of another method of arresting cells in chambers, in accordance with some embodiments of the invention;

FIG. 6A is an illustration showing cells arrested inside chambers, in accordance with the method of FIG. 5;

FIG. 6B is a side view (magnified) and FIG. 6C is a top view of a device with a chamber array designed for cryopreservation of cells, in accordance with an exemplary embodiment of the invention;

FIG. 6D is an image showing a top view, and FIG. 6E is an image showing a side view of an exemplary cryopreservation apparatus, for example of FIG. 6B and/or FIG. 6C, useful for practicing some embodiments of the invention;

FIG. 7 is a flowchart of another method of arresting cells, in accordance with some embodiments of the invention;

FIGS. 8A-8C are illustrations of the use of an embodiment of a chamber array, useful for arresting cells in accordance with the method of FIG. 7;

FIGS. 8D-8F are images of an exemplary design of a chamber, such as in FIG. 8A, useful for practicing some embodiments of the invention;

FIG. 8G is an image of an exemplary array of chambers of FIGS. 8D-8F, useful for practicing some embodiments of the invention;

FIGS. 8H-8I are images of the chamber array of FIG. 8G used in accordance with the method of FIG. 7 for practicing some embodiments of the invention;

FIG. 8J is an image of an exemplary device, useful for practicing some embodiments of the invention;

FIGS. 9A-9C are scanning microscope images of a sample chamber array used by the inventors to perform experiments, useful in practicing some embodiments of the invention;

FIGS. 10A-10C are images and figures illustrating the control experiment, showing results of some embodiments;

FIGS. 11A-11D are images and figures before the excess solution has been removed, showing results of some embodiments;

FIGS. 12A-12D are images and figures of an experiment using the 8 micrometer array, showing results of some embodiments;

FIGS. 13A-13D are images and figures of an experiment using the 12 micrometer array, showing results of some embodiments;

FIGS. 14A-14E are images and figures of an experiment using the 100 micrometer array, showing results of some embodiments;

FIG. 15A is a table and FIG. 15B is a chart illustrating the validity of the experimental results, showing results of some embodiments;

FIGS. 16A-16F are images and figures of an experiment using plugs with the chamber array, showing results of some embodiments;

FIGS. 17A-17D are images of an experiment of cryopreservation of sperm using the method of FIG. 1C, showing results of some embodiments;

FIGS. 18A-18B are images of an experiment of arresting sperm cells using the method of FIG. 5 and the chamber array of FIG. 8G, showing results of some embodiments;

FIGS. 18C-18D are images of an experiment of cryopreserving sperm cells in the array of FIGS. 8D-8I, showing results of some embodiments;

FIGS. 19A-B are bright field images of femtoliter arrays, useful in practicing some embodiments of the invention;

FIG. 19C is an atomic force microscope (AFM) image of the array of FIG. 19A, useful in practicing some embodiments of the invention;

FIG. 20 is a graph of a 3.8 fL chamber as measured by AFM and by intensity of fluorescent signals emitted by the chamber, showing results of some embodiments;

FIGS. 21A-B are overlapping images of ultraviolet (UV) and Fluorescein isothiocyanate (FITC) fluorescent images of the 3.8 fL and 1.6 fL chamber arrays, showing results of some embodiments;

FIG. 22A is a graph of a fluorescent intensity (FI) profile along the 3.8 fL chamber with arrested fluorescent liquid, showing results of some embodiments;

FIG. 22B is a graph of the amplitude of the fluorescent signal at different solution concentrations for the 3.8 fL array, showing results of some embodiments;

FIG. 22C is a graph of the amplitude of the fluorescent signal at different solution concentrations for the three arrays, showing results of some embodiments;

FIG. 22D is a graph of the intensity of the fluorescent signal as a function of volume or height of the 3 types of fL arrays, for a solution concentration of 25 microMol, showing results of some embodiments; and

FIGS. 23A-D are schematic illustrations of some examples of chambers, in accordance with an exemplary embodiment of the invention.

### DESCRIPTION OF SPECIFIC EMBODIMENTS OF THE INVENTION

The present invention, in some embodiments thereof, relates to an array of chambers, and more particularly, but not exclusively, to a method for arresting objects such as living cells and/or molecules in the chambers.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

An aspect of some embodiments of the invention relates to a method for arresting objects, such as living cells and/or non-living compounds (eg. DNA molecules) in chambers. Optionally, chambers are covered. Alternatively or additionally, chambers are plugged. Optionally or alternatively, the level of a fluid in the chambers is low enough to arrest objects in the chambers. Optionally or additionally, the objects in the chambers are cryopreserved.

In an exemplary embodiment of the invention, chambers are in fluid isolation from one another, that is, objects are prevented from moving from one chamber to another through a fluid. Alternatively or additionally, objects are prevented from leaving their respective chambers.

In an exemplary embodiment of the invention, a liquid array of chambers is formed by filling the chambers with a liquid. Optionally, excess liquid (eg. in spaces in between chambers) is evacuated. Optionally, the liquid contains a suspension of objects.

In an exemplary embodiment of the invention, arrested objects are able to move inside their respective chambers, for example, sperm cells are able to swim inside their chamber.

In an exemplary embodiment of the invention, objects are arrested in a solution. Alternatively or additionally, objects are arrested in a gel, such as a soluble gel.

In an exemplary embodiment of the invention, arrest is achieved by filling chambers with a solution to a height at or below the top of the chamber wall.

In an exemplary embodiment of the invention, arrest is achieved by a cover over the chambers. Optionally, the cover is a solid mass, such as a glass cover, for example a microscope slide cover (eg. disc shaped). Alternatively or additionally, the cover is a fluid that floats over the solution inside the chambers, such as oil. Alternatively or additionally, the cover is a film, eg. made of polymer. Alternatively or additionally, the cover repels water (e.g., hydrophobic), for example, silicone.

In an exemplary embodiment of the invention, the cover is at least partially transparent, for example, to visible light. Optionally, the chamber array is at least partially transparent, for example, to visible light.

In an exemplary embodiment of the invention, objects are inserted into chambers through the cover (eg. liquid and/or film), without removing the cover. Alternatively or additionally, objects are removed from the chambers through the cover. Alternatively, objects are manipulated inside the chambers using a tool piercing through the cover. Alternatively, objects are inserted into the chambers directly, not through the cover (eg. chambers not covered).

In an exemplary embodiment of the invention, the volume of the chambers is for example, about 0-3 μL (microliters), or about 0.5 μL-3 μL or about 0.5 μL-2.5 μL, or about 0.75 μL-1.5 μL, or about 1 μL, or other smaller, intermediate or larger ranges are used.

An aspect of some embodiments of the invention relates to plugs for arresting objects in chambers.

In an exemplary embodiment of the invention, arrest is achieved by plugging chambers with plugs (e.g., one plug for one chamber opening). Optionally, plugs are sized and/or shaped to seal the chamber, for example, to prevent leaks and/or evaporation. For example, the shape of the plug is substantially round to fit a substantially round chamber opening and/or the plug is hexagonal to fit a hexagonal chamber. Alternatively, plugs are sized and/or shaped to close off the chamber without sealing it, for example, to prevent cells inside the chamber from escaping while allowing fluid flow in and out of the chamber (for example, to maintain viability of the cells). For example, the shape of the plug is substantially round and the shape of the chamber opening is hexagonal, leaving small gaps between the plug and the chamber wall.

In an exemplary embodiment of the invention, the plugs are sized to sit at the chamber opening without falling inside. For example, the diameter of the plug is at least greater than 100% of the diameter of the chamber opening, about 120%, about 150%, or about 200% of the diameter of the chamber opening, or other smaller, intermediate or larger diameters are used. Optionally, the plugs are sized to allow two adjacent chambers to be plugged with two adjacent plugs. For example, the diameter of the plug spans no more than the diameter of the opening of the chamber plus the distance between openings of chambers. Alternatively, the size of the plugs prevents and/or reduces plugging of adjacent chambers, for example, a first plug sitting at the opening of one chamber prevents and/or reduces a second plug from sitting at the opening of an adjacent chamber. For example, at least 10%, at least 20%, at least 50%, at least 90%, or 100% of the chambers are plugged.

In an exemplary embodiment of the invention, the plugs are sized to enter the interior of the chamber through the opening of the chamber. For example, the diameter of the plug is no more than 99% of the diameter of the chamber opening, or less than 90%, less than 80%, less than 70%, or other smaller, intermediate or larger diameters are used.

In an exemplary embodiment of the invention, arresting of objects inside chambers occurs by applying a weight above the object inside the chamber. Optionally, the weight is a plug that has entered the interior of the chamber. For example, some cells have a density less than that of the solution inside the cells (e.g., oocytes, adipocytes). The cell can be prevented from leaving the chamber by the plug.

In an exemplary embodiment of the invention, plugs are placed at the opening of chambers. Optionally, plugging is achieved by plugs sinking into chambers (e.g., by gravity), for example, plugs are suspended in the solution covering the chamber. Alternatively or additionally, plugs are attracted to the chambers such as by a magnetic field. Alternatively or additionally, plugs are attracted to the chambers by electrical forces such as dielectrophoresis. Alternatively or additionally, the chamber array is vibrated. Optionally or additionally, plugs are bonded to the chambers by substances having a relatively high affinity for one another.

In an exemplary embodiment of the invention, plugs are removed from the chambers. Optionally, plugs are removed by a magnetic field. Alternatively or additionally, plugs are removed by electrical forces such as dielectrophoresis. Alternatively or additionally, plugs are removed by applying an adhesive to the surface are of the chamber (e.g., rolling a soft rubber ball over the plugs). Optionally or additionally, plugs are moved (inserted and/or removed from chambers) by other micromanipulation techniques such as optical tweezers and/or micropipette based manipulations.

In an exemplary embodiment of the invention, pressure is applied to the plugs to seal the openings of chambers, for example, by a cover pressing down on the plugs sitting at the openings of the chambers.

In an exemplary embodiment of the invention, the plugs are made out of a pliable material, for example, polydimethylsiloxane (PDMS). Optionally, the plug conforms to the shape of the chamber opening to seal the chamber. Optionally, the conformation and/or sealing of the chamber occurs by pressure applied to the plug.

In an exemplary embodiment of the invention, two or more adjacent chambers are plugged, for example, by a sufficiently large plug made out of a pliable material, with optional pressure applied to the plug. Optionally, the plug is a cover or an array of plugs that covers the entire array of chambers. Alternatively, at least some of the chambers are covered by the plug. Optionally or additionally, the plug has water repelling properties (e.g., hydrophobic), for example, made out of silicone.

In some embodiments of the invention, the plug is configured to support the insertion of a manipulating instrument (e.g., needle) through the plug, for example to to manipulate objects in side the chamber. Optionally, the plug reseals itself after the needle has been removed, for example, the plug is made out of silicone.

In an exemplary embodiment of the invention, the plugs are made out of a transparent material.

In an exemplary embodiment of the invention, an excess of the solution is removed from the chamber array, for example, from the space above and/or the space in between the chambers. Optionally, the solution is removed by a porous substance such as filter paper, for example, if the chamber array is printed on the porous substance. Optionally, the excess solution is forced out by the water repelling properties of the plug and/or cover.

In an exemplary embodiment of the invention, removal of the excess solution causes the cover to lower over and/or cover the chambers, thereby arresting and/or fluidly isolating the chambers and/or corresponding objects.

In an exemplary embodiment of the invention, loss (eg. leaks and/or evaporation) of fluid from the chambers is reduced and or prevented by placing the chamber array in an environment with a relatively high level of humidity, for example, 100% humidity. Alternatively or additionally, a sealing material is applied, for example, to the circumference and/or perimeter of the cover over the chamber array.

An aspect of some embodiments of the invention relates to arresting one or more rare and/or valuable living cells in chambers, for example, sperm cells, oocytes. In an exemplary embodiment of the invention, the respective location of the cell in the chamber is known (eg. addressable). Optionally, the array is sealed with a cover providing access to the cells inside the chambers (eg. to remove them), such as oil. Alternatively the chambers in the array are sealed with plugs. Optionally, plugs are removed from the chambers, such as to remove the cells.

An aspect of some embodiments of the invention relates to the creation of a liquid array in chambers of chemical reactions, for example, chemical reactions producing fluorescing molecules. In an exemplary embodiment of the invention, chambers are in fluid isolation from one another. Optionally, the array is sealed, for example, using a solid cover and/or a plug.

In an exemplary embodiment of the invention, the volume of the chamber for the liquid array ranges from 0.1 fL-100 fL, or 1 fL-50 fL, or 3 fL-30 fL, or 5 fL to 20 fL, or other smaller, intermediate or larger sizes are used. Optionally, the chambers are separated by gaps ranging from 1 to 30 μm, or 2 to 20 μm., or 5 to 10 μm., or other smaller, intermediate or larger sizes.

An aspect of some embodiments of the invention relates to a device to support an array of chambers. Optionally, the device has a handle and/or string for moving locations. Alternatively or additionally, the support has a relatively low heat capacity. Alternatively or additionally, the support has a relatively high thermal conductivity. Alternatively or additionally, the support is coupled to a material to remove an excess of solution from the chamber array. Alternatively or additionally, dimensions of chambers are designed to hold fluid using surface tension forces. Alternatively or additionally, a space between chambers is relatively large to reduce and/or prevent fluid from being removed between chambers, such as due to surface tension.

An aspect of some embodiments of the invention relates to an array of chambers attached to a support, the chambers separated by a gap. Optionally, the chambers are cylindrical. Optionally, the gap is large enough to prevent and/or reduce surface tension forces from holding a fluid in the gap. In an exemplary embodiment of the invention, the array of chambers is adapted to be frozen, for example, cryopreserved.

In an exemplary embodiment of the invention, the volume of the chamber is for example, on the order of an attoliter, on the order of a femtoliter, on the order of a picoliter, on the order of a nanoliter, on the order of a microliter, on the order of a milliliter, or other smaller, intermediate or larger sizes are used.

An aspect of some embodiments of the invention relates to a method of freezing (e.g., cryopreserving) an array of chambers having objects arrested therein, wherein the chambers are separated by gaps. Optionally, the objects are sperm cells. In an exemplary embodiment of the invention, the gaps are arranged to help in obtaining uniform freezing, for example, by distributing the cold substance throughout the various chambers. In an exemplary embodiment of the invention, the gaps are arranged to help with relatively fast freezing, by distributing the close substance to a close proximity to the chambers.

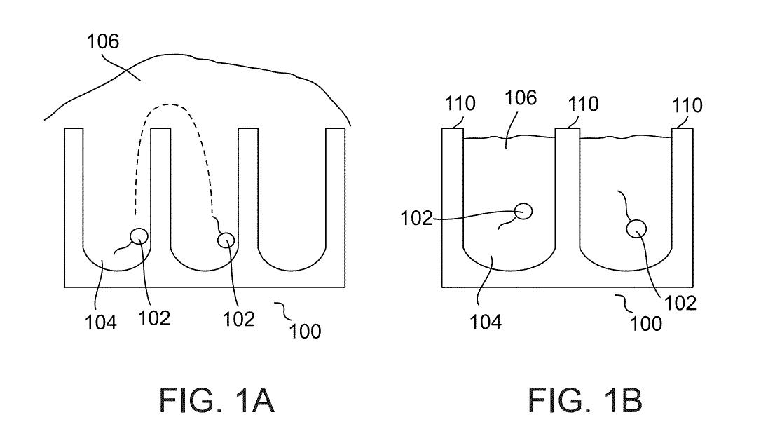

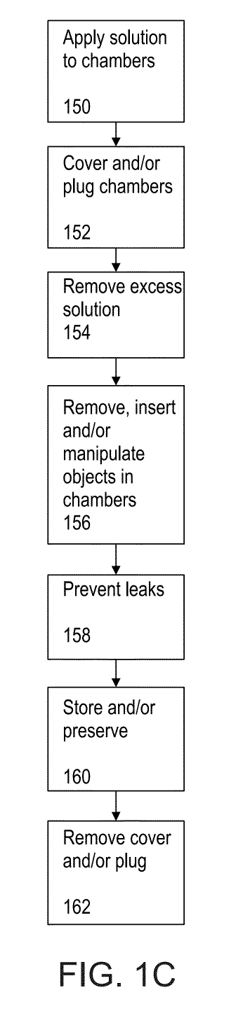

Reference is first made to the use of a chamber array 100 as illustrated in Figure 1a.

In an exemplary embodiment of the invention, array 100 is made up of one or more chambers 104. Chambers 104 are configured to hold one or more objects, for example, living cells such as sperm cells 102, oocyes and/or adipocytes, for example, non-living compounds such as DNA molecules. The diameter and/or depth of chambers 104 varies by the size of the cell and/or number of cells it is expected to hold, for example, non-limiting range from a femtoliter (eg. for studying individual molecules) to a nanoliter (eg. for studying several cells).

In some embodiments of the invention, chambers 104 are sufficiently large to hold a plurality of cells, for example, spheroids. Optionally, the cells are clumped together in one mass. Chambers 104 are sufficiently large to hold spheroids having a dimension (e.g., diameter) of at least about 150 μm, at least about 200 μm, at least about 250 μm, at least about 300 μm, at least about 400 μm.

Some examples of non-limiting dimensions include, for a chamber of femtoliter size, a diameter of 2 micrometers and/or a depth of 2 micrometers (eg. cylinder shape), for a chamber of picoliter size a diameter of 15 micrometers and/or a depth of 10 micrometers, for a chamber of nanoliter size a diameter of 200-230 micrometers and/or a depth of 100-150 micrometers, for a chamber of milliliter size a diameter of 1-2 millimeters, or about 1.2-1.8 millimeters, or about 1.4-1.6 millimeters or other smaller, intermediate or larger dimensions, and/or a depth of 1-2 millimeters, or about 1.2-1.8 millimeters, or about 1.4-1.6 millimeters or other smaller, intermediate or larger dimensions.

Some chambers are used for multi-investigation of biochemical reactions. Biochemical reactions such as protein synthesis and enzymatic conversion are fundamental to the function of living systems and are vital tools in industry and research. In this application, each chamber can act as an individual reaction center, providing for reduced reaction volumes (eg. when in the solution phase). For example, to perform high throughput biochemical reactions: high-density, low-volume assays for small chemical compounds, peptides, and proteins, for drug discovery or biological synthesis, such as enzyme assays and screening for enzyme inhibitors and/or cell-free protein synthesis (in vitro transcription and translation in a cell-free medium). Another example is to conduct single cell analysis, such as cytoplasmic characterization of individual cells like biomimetic systems for carrying out biological processes in a cellular-scale systems (in solution-phase). These include gene expression in single cells, protein synthesis in single cells and/or enzyme reactions in single cells.

Some cells are difficult to isolate in chambers. For example, cells 102 such as sperm cells have the ability to move and/or swim around. For example, oocytes and/or adipocytes are less dense than the surrounding fluid in which they are studied, potentially floating away. If chambers 104 are in fluid communication with one another, such as through a layer of excess solution 106, sperm cells 102 can swim out from a chamber 104 and/or from one chamber 104 to another, potentially making it difficult to locate and/or study cells 102.

In another example, if chemical compounds are used instead of cells 102 to study chemical reactions, fluid communication between chambers 104 can disrupt the delicate chemical composition, for example, causing reactants and/or products to flow into and/or away from the chamber, thereby affecting the results.

As it is difficult to fill chambers 104 at such low volumes, typically a drop of the solution is placed above chambers 104, resulting in an excess of solution that provides communication between chambers 104.

FIG. 1B illustrates cells 102 (eg. sperm cells, oocytes, adipocytes) and/or other objects or molecules (eg. DNA, proteins) that are arrested in respective chambers 104, in accordance with an exemplary embodiment of the invention.

In an exemplary embodiment of the invention, cells 102 are trapped and/or confined in solution 106 inside chambers 104. Optionally, solution 106 is applied over chambers 104, chambers 104 are covered, and/or an excess of solution 106 is removed. Alternatively or additionally, a fluid and/or film is used to cover chambers 104, then cells 102 are inserted together with solution 106 into chambers 104 through the fluid. Alternatively or additionally, solution 106 containing suspended objects is applied over chambers 104 and the excess solution 106 is removed. Alternatively or additionally, chambers 104 are plugged and/or sealed using plugs. Optionally, solution 106 contains the plugs.

In some embodiments, excess solution 106 is removed without removing cells 102, for example, by insertion of a needle into the chamber 104 and withdrawing fluid using the needle. Alternatively or additionally, excess solution 106 is removed by wicking, for example, by an absorbent material.

In an exemplary embodiment of the invention, chambers 104 are made out of a hydrophilic material. Alternatively, chambers 104 are processed to have hydrophilic properties, for example, there are various surface treatments methods to modify the chamber substrate for higher or lower wettability (eg. hydrophility) and/or adhesively binding and/or repelling of cells and/or molecules. Non-limiting examples of such methods include the use of chemicals (eg. coating with hydrogels, surfactants and/or other materials), oxygen plasma activation, and/or other plasma technology treatments.

In an exemplary embodiment of the invention, there is no continuity (eg. using solution 106) between solution 106 in one chamber 104 and solution 106 in another chamber 104, for example, solutions 106 do not contact one another, for example, the level of solution 106 in each chamber 104 is below the top of chamber 104. Chambers can be said to be in fluid isolation from one another. Optionally, fluid isolation prevents cells 102 and/or objects from migrating out of their respective chambers 104.

In some embodiments of the invention, walls 110 and/or top of walls 110 are hydrophobic. A potential advantage is preventing and/or reducing a bead and/or a solution from forming a fluid connecting between solutions 106 in chambers 104.

In an exemplary embodiment of the invention, chambers 104 can be made relatively small, for example, a picoliter, a femtoliter. A potential advantage of relatively small chambers 104 is to study chemical reactions in which the products and/or reactions are in the order of molecules, such as single molecules.

In some embodiments, the level of solution 106 in chambers 104 is at and/or below the level of walls 110 of chambers 104, thereby arresting cells 102 in chambers 104.

In an exemplary embodiment of the invention, the floor of chambers 104 and/or a support beneath chambers 104 are transparent. A potential advantage is that internal content can be viewed, such as using a light microscope.

In some embodiments, cells 102 are cryopreserved (freezing and storage of biological material at temperatures below −130° C.) to store and/or preserve the specific characteristics of cells for nearly unlimited periods of time. The array 100 with cells 102 inside solution 106 can be frozen together. Optionally, array 100 and/or chambers 104 are made out of a material with a relatively low thermal capacity to allow for relatively rapid cryopreservation. The protocol of cryopreservation may vary according to, for example, the cell type, size and the cryopreservation media and/or methods.

FIG. 1C is a flowchart of a method to arrest cells in chambers 104, and/or to fluidly isolate chambers 104 from one another, in accordance with an exemplary embodiment of the invention. Various embodiments of the method will be explained in more detail below.

At 150, a solution is applied to the chambers. Optionally, the solution is applied to several chambers at once, for example, by applying a drop of solution over the chambers. Alternatively or additionally, the solution is applied to chambers individually, for example, in a controlled manner, such as by injection directly into the chamber.

In some embodiments, the solution is selectively applied (eg. injected) to non-adjacent chambers, thereby creating buffer zones between adjacent chambers (eg. fluid filled chambers are surrounded by non-fluid filled chambers). A potential advantage of this method is that no cells are lost, for example, if the cells are unable to escape from the solution, the cells become arrested in the solution. This is an important feature such as for low viability sperm samples.

In some embodiments, a gel is used instead of a solution. Optionally, the gel is liquefiable, such as from a gel to a solution and/or from a solution to a gel. Non limiting examples of gel include, various types of hydrogels (eg. highly absorbent (over 99% water) natural or synthetic polymers) such as Agarose (including low melting Agarose, a high strength gel with a low melting temperature), Alginate, Matrigel. One or more potential advantage of using the gel include; preventing movement of cells or molecules within the chamber; the gel can contain essential nutrients to support the cells; the gel can contain agents that react with molecules released by the cells and/or chemical reactions taking place in the chamber to identify the released molecules and/or chemical reactions, for example, resulting in a fluorescent signal.

In some embodiments, the solution contains the cells (eg. sperm, oocytes, adipocytes) and/or objects (eg. DNA) to be studied. Alternatively or additionally, the cells and/or objects are added to the chambers separately.

In some embodiments, the solution contains plugs, for example, suspended therein. Alternatively or additionally, the plugs are inserted into the solution separately.

Optionally, at 152, the chambers are covered and/or plugged. Optionally, chambers are covered by a rigid mass, such as a glass cover. Alternatively or additionally, chambers are covered by a liquid, for example, having a density less than that of the solution and/or the cells inside the chambers, such as oil. Alternatively or additionally, chambers are covered by a relatively thin film, for example, Formvar Resin available from SPI supplies. Alternatively or additionally, chambers are covered by a gel.

In an exemplary embodiment of the invention the cover is transparent; a potential advantage is that contents inside the chambers can be viewed via transmitted light while the cover is on, such as using a light microscope.

In some embodiments of the invention, the chambers are plugged, for example, one plug blocks and/or ‘plugs’ the opening of one chamber. Optionally, the plug enters the interior of the chamber.

In some embodiments, all of chambers 104 are plugged. Alternatively, at least some of chambers 104 are plugged.

In some embodiments of the invention, the chambers are plugged and then covered. A potential advantage is relatively improved sealing of the chambers, for example, the cover applies a force to the plugs to maintain the plugs in the chambers, and/or the applied force molds the pliable plug into the shape of the chamber opening to seal any gaps between the plug and the chamber.

In some embodiments, the chambers are first filled with solution as in 150, and then covered and/or plugged as in 152.

In some embodiments, the chambers are first covered and/or plugged as in 152, and then filled in as in 150.

Optionally, at 154, an excess of solution is removed, for example, from above the chambers and/or between the chambers. Optionally, removal of the excess solution is accomplished by pumping the solution through a porous substance (eg. filter paper), such as by supplying a pressure gradient over the porous substance. Alternatively or additionally, removal is accomplished by absorbance of the excess solution by the porous substance (eg. by capillary action). Alternatively or additionally, removal is accomplished by removal using a syringe. Alternatively or additionally, the excess solution is forced out by the hydrophobic properties of the chamber walls and/or the plug and/or cover. In some embodiments, the plug and/or cover mechanically pushes out excess material. A potential advantage of removing the excess solution is that the cells are kept in place, unable to escape past the solution in the chamber.

In some embodiments, removing the excess solution causes the cover (as in 152) to close over the chambers, for example, the cover is pulled down by gravity, thereby arresting the cells and/or objects and/or solution in chambers. Optionally, removing the excess solution causes the cover to press down against the plugs in the chambers, for example, by surface tension.

Optionally, at 156, cells and/or objects inside the chambers are manipulated mechanically and/or chemically. Alternatively or additionally, cells and/or objects are removed from the chambers. Alternatively or additionally, cells and/or objects are inserted into the chambers.

In some embodiments, manipulation, insertion and/or removal occurs through the cover, for example, by using a relatively extremely thin needle connected to a micromanipulator (e.g. Eppendorf FemtoJet® Microinjector) to pierce through oil and/or thin film.

Optionally, at 158, evaporation and/or leaks (eg. of solution) from the chambers is prevented and/or reduced.

In some embodiments, the chambers are placed in an environment having a relatively high humidity, such as 100% humidity.

In some embodiments of the invention, pressure is applied to seal the chambers, for example, by pushing the cover and/or plug (e.g., combination of one or more covers and/or plugs) against the opening of the chamber. Non-limiting examples of ways to apply pressure include; physically pressing down on the cover (e.g., using a finger, using a robot), applying a liquid (e.g., water, oil) over the cover and/or plug (e.g., force of gravity), relatively increasing the air pressure above the liquid and/or plug, relatively reducing the air pressure (e.g., vacuum) under the liquid and/or plug.

Optionally, at 160, the chambers are stored.

In some embodiments, chambers are sealed, for example, to allow for chemical reactions to take place without external contamination. Optionally, the perimeter and/or circumference around at least some of the cover is sealed, for example, using one or more suitable sealing materials such as Rubber Cement, Fixogum (available from Kreatech Diagnostics, The Netherlands), dental sealing material (eg. GuttaFlow, AHPlus).

In some embodiments, a solid cover such as a glass cover is used for the liquid array version of the chambers (eg. study of chemical reactions). A potential advantage is to create a strong seal that does not need to be opened. Another potential advantage is that once covered, if agitated, chambers will not leak.

In some embodiments, a liquid (eg. oil) and/or film cover is used to arrest living cells in the chambers. A non-limiting example of a film for cell culture which allows for air and/or gas exchange is EasyApp Microporous Film, available from USA Scientific Inc. A potential advantage is to provide for removal of cells (eg. through cover), such as after storage. Another potential advantage is that pores can pass air to the cells in the chambers.

In some embodiments, a solid cover used to arrest living cells in the chambers is made out of a gas-permeable material. Alternatively or additionally, the chambers and/or support are made out of a gas-permeable material, for example, permeable to carbon dioxide and/or oxygen. Optionally or additionally, the chambers are gas sealed, and a gas source is attached to control the atmosphere. A potential advantage is to supply the cells with nutrition and/or oxygen and/or to remove waste.

In some embodiments, the chambers are stored, for example, using crypreservation, such for chambers containing living cells.

In some embodiments, living contents of chambers are sustained, for example, by allowing nutrients and/or gasses (eg. food, waste) to diffuse into and/or out of chambers, such as by having walls of chambers made to be porous.

Optionally, at 162, the cover and/or plug are removed, for example, to remove cells from the chambers. In some embodiments, the solution and/or cells are not pulled out with the cover due to surface tension forces that maintain the solution in the chamber. Optionally, the cover is removed by directly applying a force such as using forceps and/or using an adhesive (e.g., to assist in applying the force on the cover and/or plug away from the chamber), for example, a user manually removing the plug and/or cover and/or a robot automatically removing the plug and/or cover, with the aid of an adhesive that binds the cover and/or plug to a tool used by the user and/or robot to remove the plug and/or cover. Alternatively or additionally, the cover and/or plug are removed by a remotely acting force, for example, a magnetic field and/or dielectrophoresis.

Optionally, the cover as in 152 is applied before removing the plug, for example, oil is floated over the plug and/chamber. Optionally, the plug is removed through the oil, leaving the oil covering the chamber. A potential advantage is removing the plug while maintaining arresting the object inside the chamber using the oil.

### Potential Advantages

A potential advantage of arresting cells using methods and/or devices in accordance with embodiments of the invention, is to study cells that would otherwise not remain confined to the chambers. For example, cells with the ability to move (e.g., having the ability to swim using under their own power), such as sperm cells, bacteria, protozoa (eg. using flagella), may be able to ‘jump’ or ‘swim’ (eg. in excess solution) away from their chamber, unless arrested in the chambers. For example, cells that float in solution such as oocytes and/or adipocytes may drift away from their chamber, unless arrested.

Another potential advantage is the ability to arrest individual cells in a known location and return to that location. A related potential advantage is the ability to insert cells into the known chamber, and subsequently remove the cells at a later point in time without damaging or losing the cells, such as after thawing cryopreserved cells. For example, in fertility treatment patients may have a low sperm count. The sperm are sparse and valuable, therefore individual sperm cells need to be carefully identified and handled. In another example of fertility treatment, patients may have a normal sperm count, but may have a relatively low percentage of healthy sperm. The healthy sperm need to be carefully identified, selected and handled.

A potential advantage and/or application is the ability to arrest valuable cells (e.g., sperm cells) in a known location, preserve the cells (e.g., by cryopreservation), transport the cells (e.g., relatively far distances, such as across borders) and then retrieve the cells at the right location and/or at the right time.

A potential advantage of arresting particles using methods and/or devices in accordance with embodiments of the invention, is to study Cell-Free Protein Synthesis (CFPS), for example, as described by Mei at el, in the reference cited in the background. The reaction solution contains DNA extract, amino acids and the protein vectors, all are commercially available. Various concentration of the different various molecules, as well as different dimensions of the chambers can be used.

A potential advantage of arresting cells and/or particles using methods and/or devices in accordance with embodiments of the invention, is to analyze the cytoplasmic contents of single cells in large cell populations, for example, as described by Lee et al, in the reference cited in the background.

A potential advantage of arresting particles using methods and/or devices in accordance with embodiments of the invention is to perform analysis (e.g., chemical and/or biochemical) in parallel. The compartmentalization of the reactions within the chambers potentially facilitates ultra sensitive analytical measurements, for example, down to single molecule detection. For example, it can be possible to analyze a large number of individual enzyme molecules simultaneously in solution. Furthermore, lack of fluid communication makes it easy to make sure that reactions and/or processes do not affect each other by mistake. In addition, spills might be confined to gaps, thereby helping to prevent cross reactivity or contamination between chambers.

### Additional Exemplary Applications

The following are non-limiting exemplary applications of studying cells in an array of chambers, in accordance with some embodiments of the invention.

Cryo-preservation of oocytes: Freezing of oocytes (human eggs) is highly interesting not only for human reproductive medicine but for agriculture industry. Oocytes are usually cryopreserved with vitrification protocols, which implement very fast cooling rates. The oocyte is the largest cell in the human body (<100 μm) and contains a great amount of water. Before freezing, the egg must be dehydrated by incubating in the presence of cryoprotectants, which replace the water within the cell and inhibit the formation of ice crystals. The vitrification process is fast and requires higher concentrations of cryoprotectants to be added to the medium. The high concentrations of cryoprotective agent increase the density of the vitrification solution, and cause the oocytes to float. An example for vitrification media: Dulbecco's phosphate-buffered saline (Gibco BRL, Grand Island, N.Y.) supplemented with 1.5 M of ethylene glycol (E-9129; Sigma, St. Louis, Mo.) and 10% (vol/vol) fetal bovine serum (Gibco BRL) at 37° C. (Fertil Steril. 2003 June; 79 (6):1323-6).

Culturing and measurements of Adipocytes: Freshly isolated adipocytes (fat cells) are a widely used and important tool for studying fat cell physiology, stem cells and metabolic disorders that affect adipose tissue such as diabetes mellitus and obesity. The most prominent feature of these cells is a lipid droplet that comprises 80-90% of their intracellular volume, which causes them to float in physiological solutions (e.g buffers and cell culture media). Therefore the application of routine cell biological techniques including cell culturing is very problematic and challenging.

Arresting adipocytes and/or oocytes in chambers using devices and methods in accordance with embodiments of the invention potentially allows the study of the cells in a controlled manner.

### Exemplary Method Of Arresting Objects

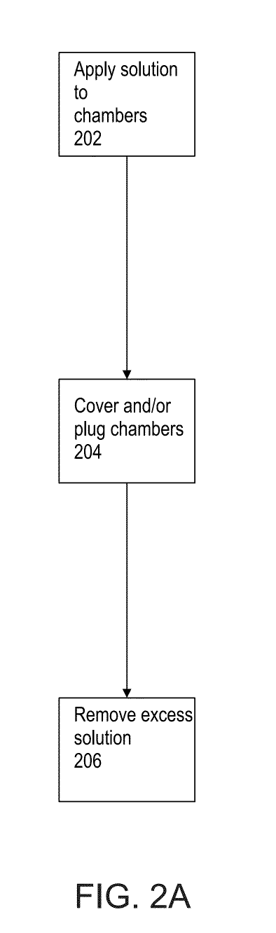

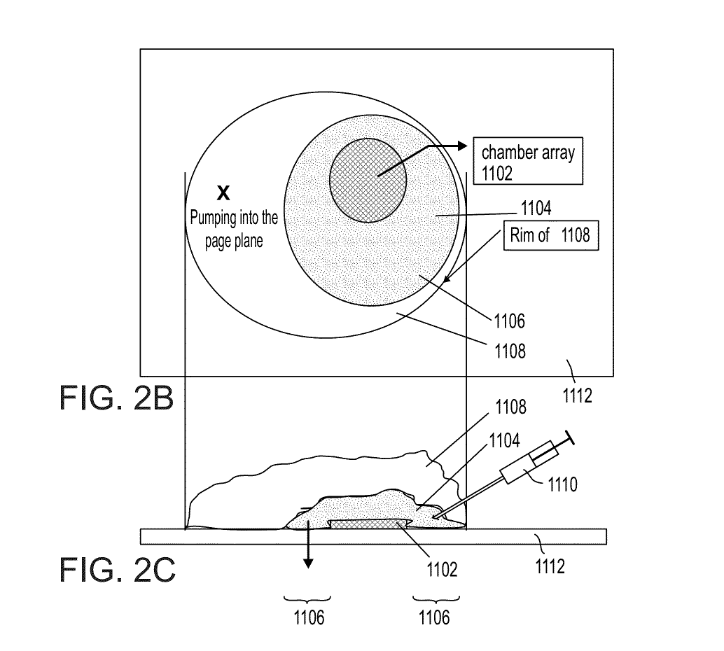

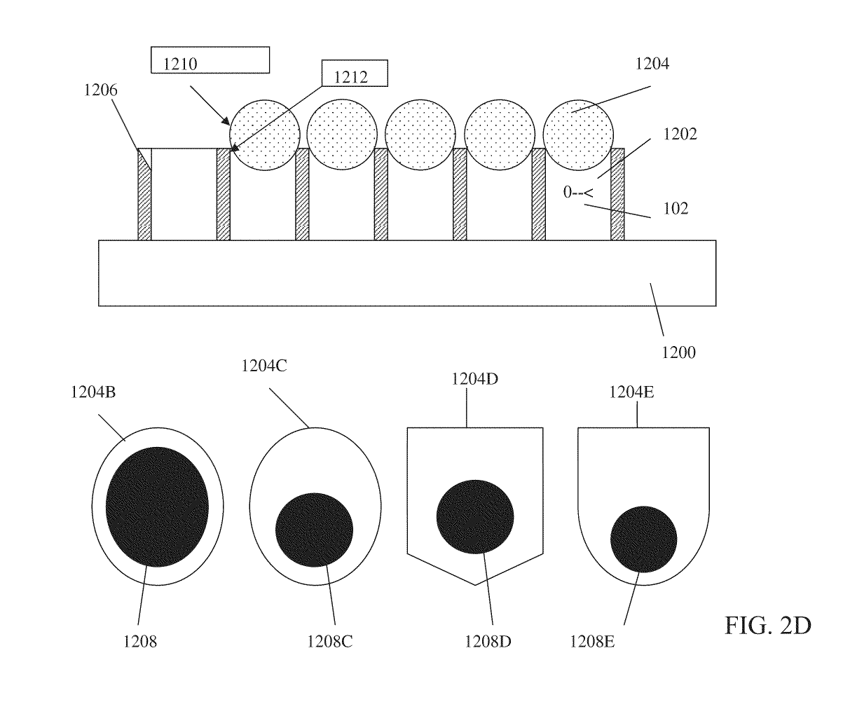

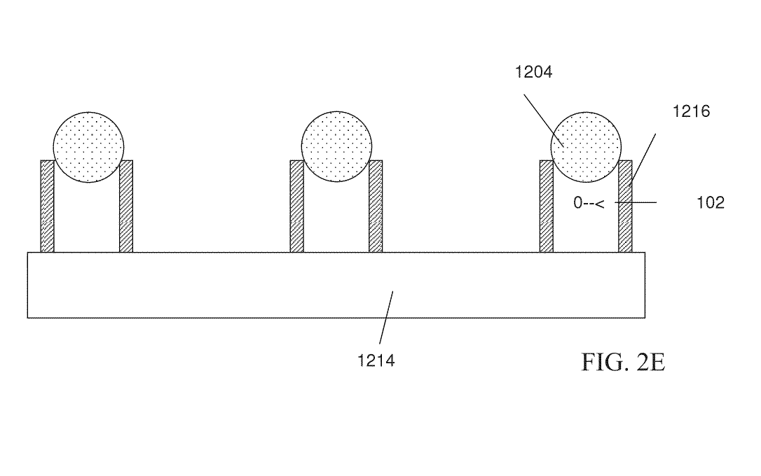

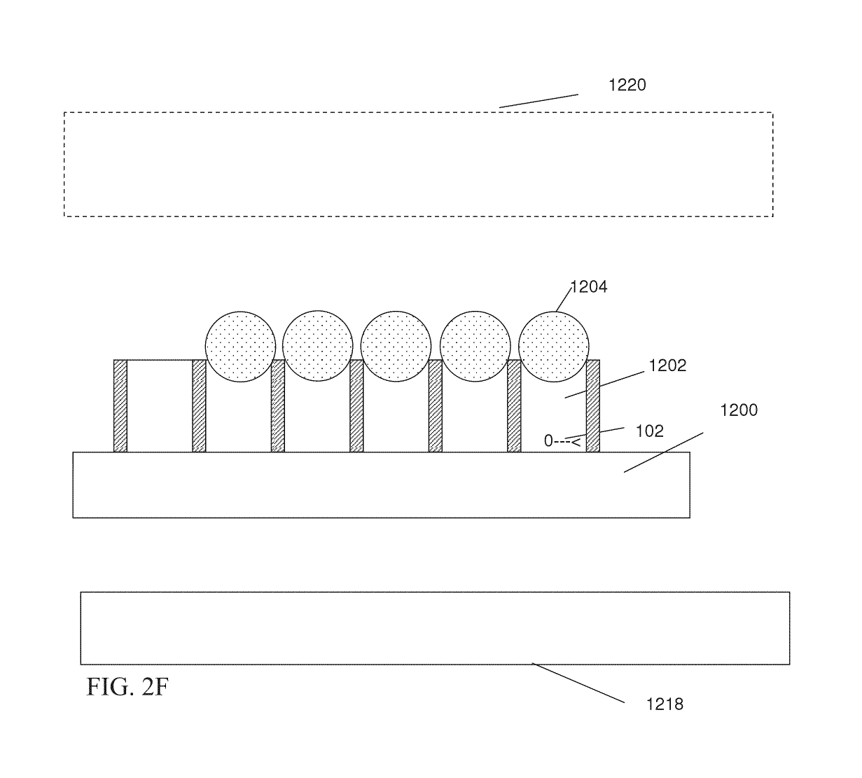

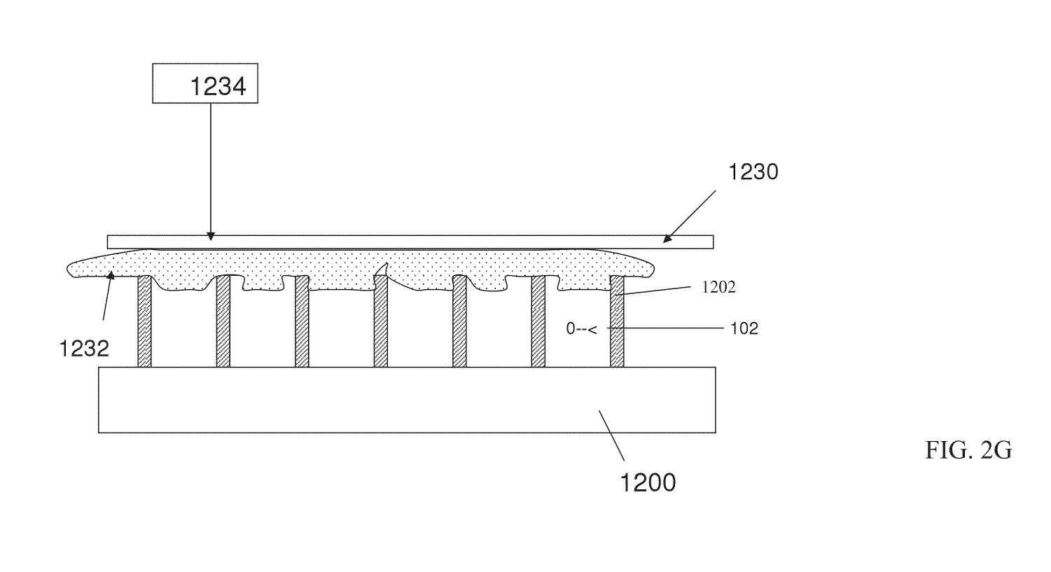

FIG. 2 illustrates an exemplary method of arresting cells and/or non-living objects in individual chambers such as illustrated in FIG. 1. The method will be described with reference to images 3A-D.

In an exemplary embodiment of the invention, a cell and/or particle is arrested in the chamber.

In an exemplary embodiment of the invention, fluid communication between chambers, such as between adjacent chambers, is prevented.

At 202, a solution is applied to the chamber array, in accordance with an exemplary embodiment of the invention. The solution can be applied in a controlled manner, for example, using a pipette.

In an exemplary embodiment of the invention, the solution contains suspended objects (eg. DNA, compounds for chemical reactions) to be studied.

In an exemplary embodiment of the invention, the volume of the solution is in excess in relation to the total volume in the chambers, for example, about 1×, about 3×, about 5×, about 10×, about 100× the volume inside the chambers, or other smaller, intermediate or larger factors.

Image 3A illustrates a support, such as a microscope slide 302, the right side (eg. relatively paler area) of which has been processed into a chamber array 330, for example, using one or more not necessarily limiting manufacturing methods such as milling, etching, embossing. From the area of array 330, two areas of embossed chamber arrays 304 have been selected to illustrate the method, in accordance with an exemplary embodiment of the invention. A drop of 5 microliters of a solution 306 has been applied to each array 304.

At 204, the chamber arrays are covered and/or plugged, in accordance with an exemplary embodiment of the invention. In some embodiments, the cover is made of a rigid material such as glass. Optionally, the cover is pressed down (eg. manually by using a finger or by a weight).

In an exemplary embodiment of the invention, the size of the cover is sufficient to cover a selected region of chambers array. Optionally, the cover is larger than the selected region, for example, to allow for misalignment.

Exemplary Details about ‘plugging’ are described with reference to the section “PLUGS”.

Image 3B illustrates a cover 308 being placed over chamber array 304, in accordance with an exemplary embodiment of the invention. Cover 308 is made out of glass. The diameter of cover 308 is about 8 mm.

In an exemplary embodiment of the invention, cover 308 is applied manually using tweezers 310.

Image 3C illustrates covers 308 over both chamber arrays 304, in accordance with an exemplary embodiment of the invention.

At 206, excess solution is removed, in accordance with an exemplary embodiment of the invention.

In an exemplary embodiment of the invention, fluid is removed slowly, for example, by using a porous absorbent substance (eg. absorbant paper) to remove the excess fluid. Optionally, filter paper is used to remove the excess fluid. Alternatively or additionally, the fluid can be wicked away, such as without absorbing. Potentially, at least some of the cells remain in the chambers even as the excess fluid is removed.

In an exemplary embodiment of the invention, the fluid around the cover is removed by a micropipette.

In an exemplary embodiment of the invention, fluid removal is stopped when no more liquid is absorbed by the filter paper, such as the filter paper remaining dry. In some embodiments, the filter paper and/or a wick is left in the gap, for example, to maintain the dry state such as in the case of spills.

In an exemplary embodiment of the invention, the cover becomes attached to the surface of the chamber arrays and/or surrounding surface, for example, tightly attached. In an exemplary embodiment of the invention, a substantial volume of the solution in left inside the chambers. Optionally, the cover rests over the surface of the chambers, supported by the walls of the chambers, without fluid between the cover and the upper surface of the walls (eg. rim) of the chambers.

Image 3D illustrates an absorbent paper 312 (eg. used manually) to remove excess fluid 314 around cover 308. Alternatively, the filter paper and/or other porous substance is integrated with the chamber array, for example, around and/or below the array to remove the excess fluid 314, such as will be described with reference to FIGS. 2B and 2C.

### Method of Arresting Objects

FIG. 2B (top view) and FIG. 2C (side view) illustrate an apparatus for arresting objects in chambers by removal of excess solution, for example, using the method of FIG. 2A, in accordance with some embodiments of the invention.

As in 202, a solution 1104 is applied to a chamber array 1102. Optionally, a volume of solution 1104 is in excess of the capacity of array 1102, for example, forming overflow regions 1106.

In some embodiments of the invention, solution 1104 contains compounds and/or molecules to be studied in chambers suspended therein.

As in 204, chambers are optionally covered. In some embodiments of the invention, the cover is a fluid 1108 that floats over solution 1104, for example, oil. In some embodiments, fluid 1108 optionally floats over solution 1104.

Optionally, fluid 1108 is less dense than solution 1104. Alternatively or additionally, fluid 1108 is insoluble in solution 1104. Alternatively or additionally, fluid 1108 is relatively more viscous than solution 1104. Alternatively or additionally, fluid 1108 is hydrophobic and/or non-polar. Alternatively or additionally, fluid 1108 sticks to a rigid cover, for example, fluid 1108 is underneath rigid cover and floats over solution.

In some embodiments, the rigid cover is optionally made out of a material to prevent it from slipping over solution 1104 and/or help the rigid cover stick to solution 1104, for example, rigid cover has the same polarity (eg. hydrophobic or hydrophilic) as solution 1104.

In some embodiments, an optional volume of fluid 1108 is sufficiently large to cover most or all of solution 1104.

In some embodiments, fluid 1108 is non-toxic to cells and/or non-reactive with particles to be inserted into chambers.

In some embodiments, fluid 1108 is oil.

In some embodiments, fluid 1108 is applied manually and/or automatically, such as by a pipette.

A potential advantage of using oil is that it reduces potential ‘splashes’ of solution 606 between chambers 604, for example, during handling of the device by a user.

As in 206, an excess of solution 1104 is optionally removed. In some embodiments, excess solution 1104 is removed by a porous substance 1112, for example, filter paper. Optionally, array 1102 is coupled to substance 1112, for example, printed on it, placed on it, glued to it. Optionally, removal of excess solution 1104 is accomplished by pumping solution 1104 through and/or into substance 1112, for example, by supplying a pressure gradient over substance 1112. Alternatively or additionally, removal of excess solution 1104 is accomplished by absorption in to porous substance 1112, for example, by capillary action.

In some embodiments, excess solution 1104 is removed by a needle 1110 (eg. manually and/or automatically). In some embodiments, needle 1110 pierces through fluid 1108 to reach solution 1104 to remove it.

In some embodiments, removal of excess solution 1104 causes fluid 1108 to cover chambers in array 1102, thereby isolating chambers from one another and/or providing a chamber in which a cell can be arrested (eg. can't escape from chamber).

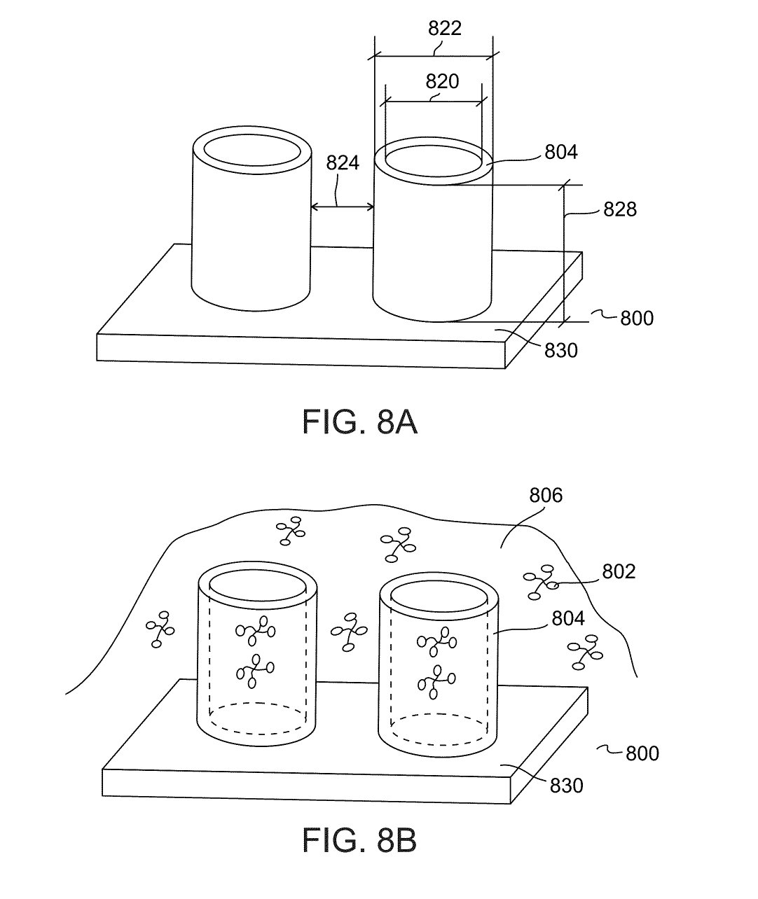

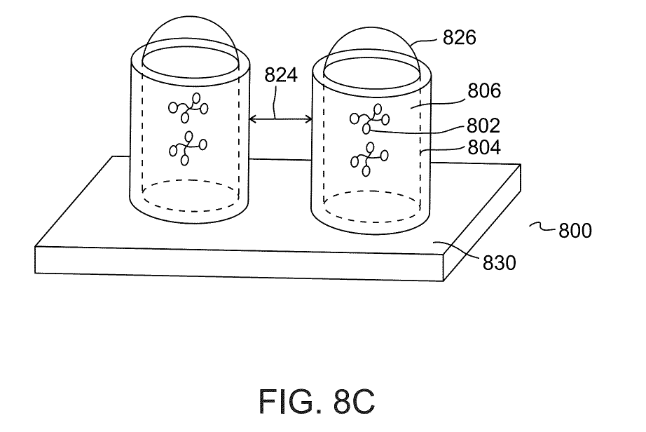

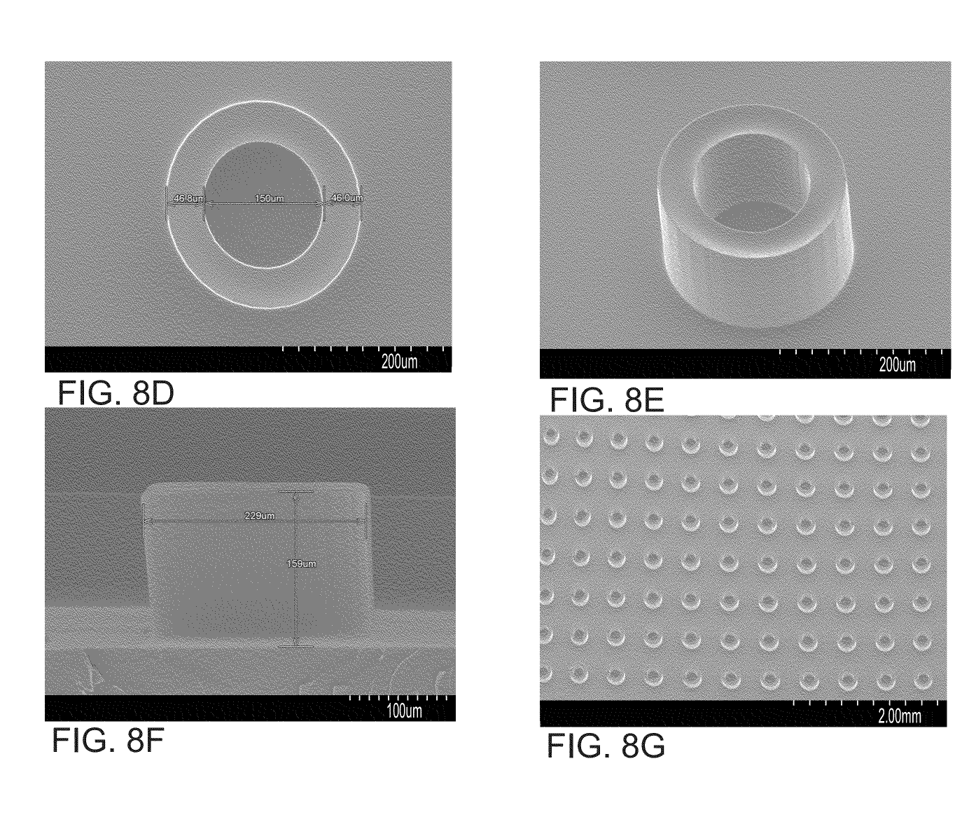

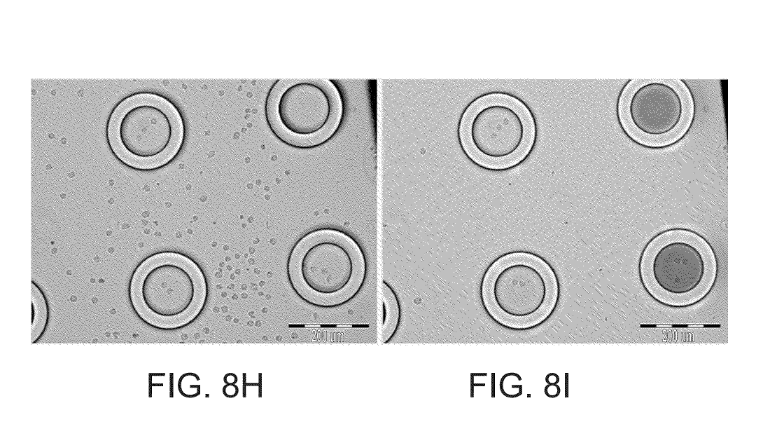

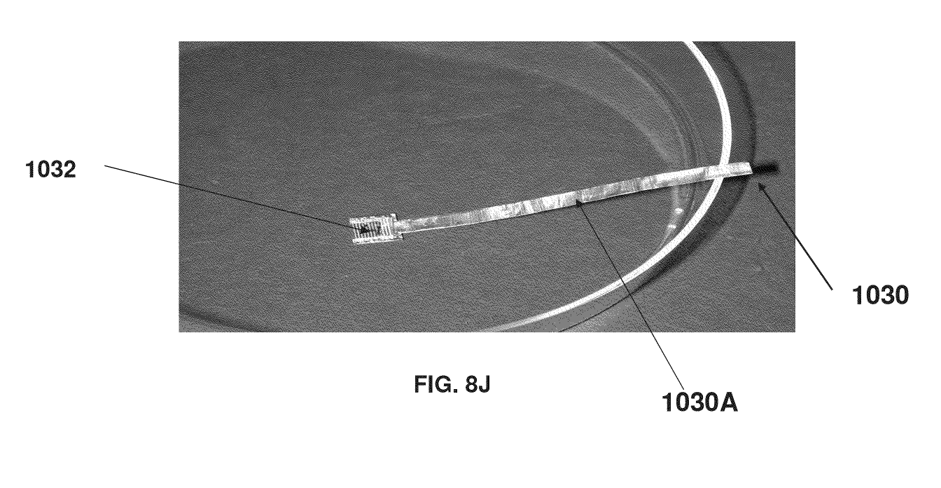

In some embodiments, removing excess solution 1104 does not remove solution 1104 inside chambers of array 1102, for example, if using array as described with reference to FIGS. 8A-8C.

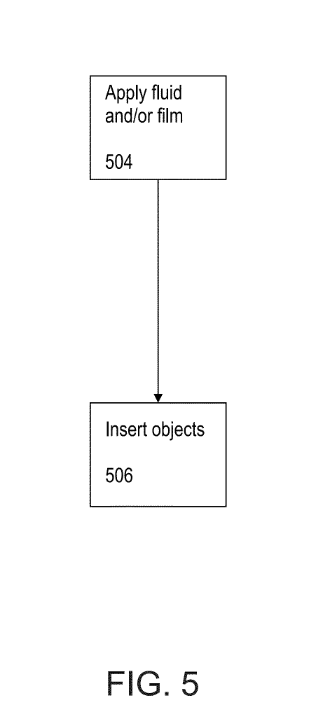

In some embodiments, cells and/or other objects can be inserted, removed and/or manipulated in chambers, for example, by needle 1110 through fluid 1108, such as described with reference to box 158 of FIG. 1C or box 506 with reference to FIG. 5.

### Arrested Objects

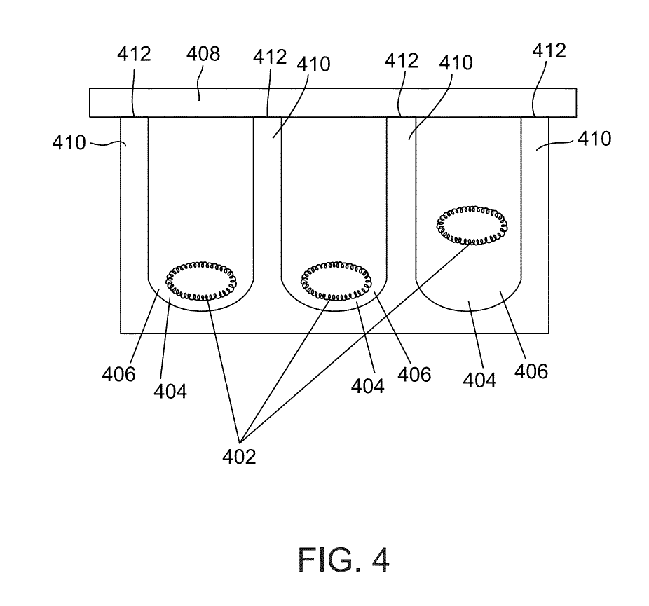

FIG. 4 is an illustration of arrested objects 402 (eg. compounds or molecules such as DNA or proteins for chemical reactions) inside chambers 404, for example, after performing the method as in FIG. 2, in accordance with an exemplary embodiment of the invention.

In an exemplary embodiment of the invention, a cover 408 rests on a top surface 412 of walls 410 of chamber 404, isolating solution 406 inside chamber 404, thereby causing objects 402 to be arrested inside their respective chambers 404.

In an exemplary embodiment of the invention, chambers 404 are filled with solution 406. Optionally, solution 406 contacts cover 408, increasing the adhesive forces holding cover 408 over chambers 404.

In an exemplary embodiment of the invention, solution 406 inside chambers 404 is not in fluid communication between adjacent chambers 404.

In an exemplary embodiment of the invention, solution 406 fills up the entire volume of chambers 404.

It should be noted, that in some embodiments, at least some chambers 404 contains a single object 402, such as a DNA molecule. For example, if volume of chamber 404 is relatively small (eg. order of femtoliter), solution 406 can be selected to have a concentration (eg. relatively dilute) such that when solution 406 is applied over chambers 404, for example, as in box 202 of FIG. 2A, a single molecule such as a DNA molecule (or compounds to react to produce a single amino acid sequence) will be arrested in chamber 404.

### Exemplary Plugs

FIGS. 2D-2F illustrate an exemplary system for arresting objects (e.g., sperm cells 102) in chambers by plugs, for example, using the method of FIG. 1C and/or FIG. 2A, in accordance with some embodiments of the invention.

FIG. 2D illustrates an array 1200 of chambers 1202 which are relatively close together, non-limiting examples include; array 100 as illustrated with reference to FIG. 1B, the hexagonal chamber array as shown with reference to images 10A-10B, or other chamber arrays can be used, for example, square arrays.

In some embodiments of the invention, a plug 1204 closes off the openings to chamber 1202. Optionally, plug 1204 has a dimension (e.g., diameter) that is relatively larger than the dimension (e.g., diameter) of the opening of chamber 1202, for example, at least 10% larger at least 30% larger, at least 50% larger, at least 100% larger, or other smaller, intermediate or larger values are used. A potential advantage of the plug diameter being relatively larger than the diameter of the opening of the chamber is preventing and/or reducing the risk of plug 1204 entering the interior of chamber 1202, instead of blocking the opening to chamber 1202. A potential advantage of the plug diameter being slightly larger than the diameter of the opening of chamber (e.g., above 100% of the diameter, about 110% of the diameter) is to reduce the inclination of the plug from rolling off the chamber opening. Relatively smaller plugs can exert a greater force (e.g., gravitational, magnetic) directed towards the opening of the chamber. Relatively larger plugs can exert a lesser force directed towards the opening of the chamber, and a relatively larger force directed away from the opening of the chamber.

In some embodiments, the diameter of plug 1204 is relatively smaller than the diameter of chamber 1202 opening plus the thickness of the wall of chamber 1202 (e.g., half the wall thickness). A potential advantage is to limit the size of plug to allow plugs to enter adjacent chamber openings by the plug not blocking the adjacent chamber openings. In some embodiments, the diameter is also taped, for example, aligning the plug to the chamber. In some embodiments, the diameter of plug 1204 is relatively larger than the diameter of chamber 1202 opening plus the thickness of the wall of chamber 1202.

In some embodiments of the invention, the diameter of plug 1204 is relatively smaller than the diameter of chamber 1202 opening, but still too big for the cell to swim around to escape. The diameter of plug 1204 is for example, about 95% of the diameter of chamber 1202, or about 90%, about 80%, about 70% of the diameter, or other smaller, intermediate or larger sizes are selected. Alternatively or additionally, the chamber itself has a tapered diameter, so that the plug can get stuck once the plug falls far enough into the chamber. Optionally, plug 1204 is relatively denser than the solution inside chamber 1202. A potential advantage is that plug 1204 enters the interior of chamber 1202. Optionally, plug 1204 acts as a weight against cell 102 inside chamber 1202. A potential advantage is that plug 1204 can prevent cell 102 from floating and/or swimming away (e.g., cells that float in the solution inside chamber 1202 such as oocytes, adipocytes and/or cells that ‘swim’ such as sperm cells) from chamber 1202.

In some embodiments of the invention, plug 1204 has a shape to substantially fit the opening of chamber 1202. Optionally, the plug is substantially round, for example, plugs 1204B and/or 1204C and the shape of the opening of chamber 1202 is substantially round. Alternatively, one part of the plug is substantially round, for example, plug 1204E has one rounded end, and one squared end.

In some embodiments of the invention, the shape of the rim of the opening of chamber 1202 is designed to better fit a corresponding plug, for example, angled rim 1206 of chamber 1202 fits plug 1204D with one end having a similar angle. A potential advantage is relatively improved sealing of chamber 1202, for example, to prevent and/or reduce evaporation and/or leakage of fluid from the chamber. Rim has a depth of about 5% of the height of chamber 1202 wall, or about 10%, or about 15%, or about 20%, or other smaller, intermediate or larger values are used.

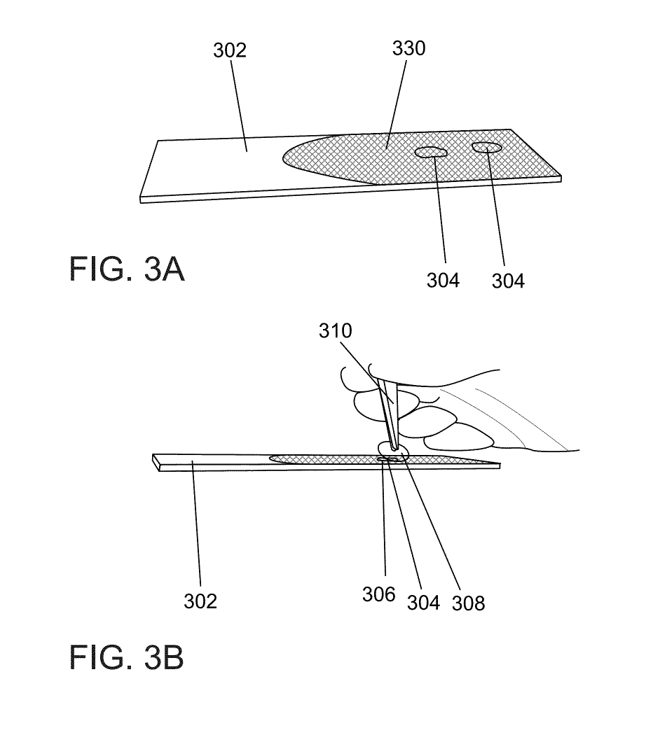

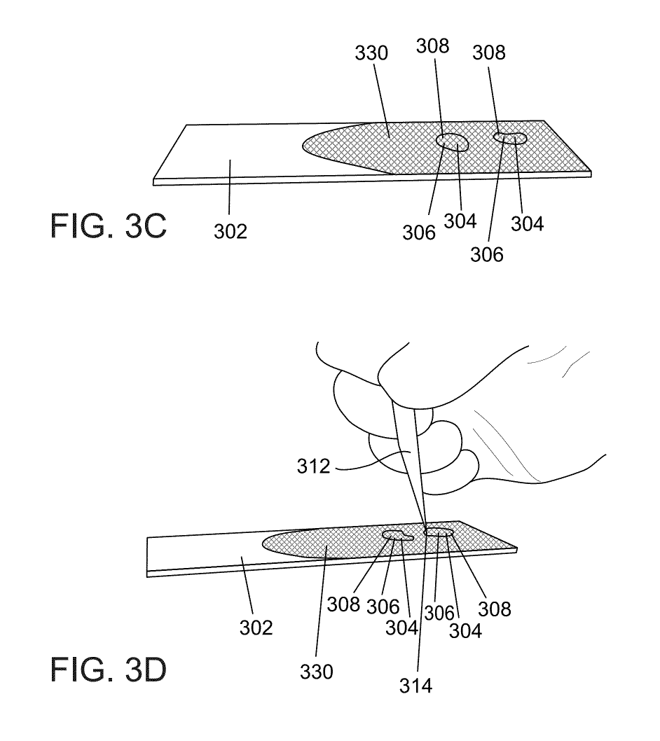

In some embodiments of the invention, plug 1204 is made from a pliable material such as polydimethylsiloxane (PDMS) and/or rubber. A potential advantage is that plug 1204 can conform to the shape of the opening of chamber 1202, thereby creating a relatively improved seal. Alternatively or additionally, plugs 1204 are pressed into the opening of chamber 1202, for example, by applying pressure such as using a cover over the chamber array as illustrated with reference to FIG. 3B.

In some embodiments of the invention, plug 1204 is made out of a transparent material. Non-limiting examples of materials include; glass, plastic, rubber, PDMS.

In some embodiments of the invention, plug 1204 is porous, for example, nutrients diffuse into chamber 1202 through plug 1204 and/or waste diffuses out of chamber 1202 through plug 1204, such as to keep cells in chamber 1202 alive.

In some embodiments of the invention, plug 1204 is filled with a substance. For example, plug 1204 can be filled with a cryopreservative. A potential advantage is relatively improved crypreservation of cells 102 inside chamber 1202.

In some embodiments of the invention, plug 1204 couples to cell 102 inside chamber 1202. For example, plug 1202 contains a substance on the surface that binds to cell 102, such as an adhesive. A potential advantage, is that cell 102 is removed from chamber 1202 together with plug 1202. A further potential advantage is that cell 102 is arrested on plug 1204, preventing loss of cell 102.

In some embodiments of the invention, plugs 1204 are designed to arrive at the entrance of chamber 1202. Optionally, plugs 1204 have a density relatively higher than a density of a solution covering chambers 1202. Plugs 1204 can sink in the solution, and fall into place at the opening of chamber 1202. A potential advantage is that even if chambers 1202 are spaced apart (e.g., as illustrated with reference to FIG. 2E), there will be at least some plugs 1204 that will fall into chambers 1202. In some embodiments, plugs 1204 have a relatively dense core 1208 (e.g., made out of metal such as iron) to sink plugs 1204. Optionally, plugs 1204 are selectively dense, for example relatively denser at one end, for example, plug 1204 may have core 1208 made out of a paramagnetic material or a magnet (e.g., iron). The relatively denser end of the plug can cause the plug to selectively sink at the denser end and fall into position at the rim of the chamber. For example, relatively dense cores 1208C-1208E are selectively placed at the shaped end of plugs 1204C-1204E to cause the plugs to selectively sink at the shaped end. Potentially, the magnetic material helps to align the plugs, seal the chambers, unseal the chambers, and/or remove fluid from the chamber (e.g., by acting as an individual plunger), for example, as will be described below in more detail. In some embodiments, the plug is electrically charged.

In some embodiments of the invention, plugs 1204 are designed to assist in correctly orienting plug 1204 to chamber 1202 opening. The described examples of plug shapes and/or densities are meant to be non-limiting. For example, plugs can have a conical shape, a spherical shape, or just have a bump at one end and/or a narrowing at the other end. The shape of the plug can be used in combination with various density embodiments of the plug, non-limiting examples include; a weight at the narrow side and/or a hollow volume in the relatively wider side.

In some embodiments of the invention, plugs 1204 are bonded to chambers 1202. Optionally, at least some of plugs 1204 (e.g., the part to fit in the rim of the opening of chambers 1202) are coated and/or made out of a first substance 1210, for example, streptavidin and/or a paramagnetic material. Optionally or additionally, at least some part of the chambers 1202 (e.g., the part of the rim to fit plugs 1202) are coated and/or made out of a second substance 1212 having a relatively high affinity for first substance 1210, for example, biotin, and/or a magnet. Optionally, the strength of the bond is relatively strong, for example, sufficient to prevent plugs 1204 from moving out of position at the opening of chamber 1202. Other non-limiting examples of properties of properties of the bond between plugs 1204 and chambers 1202 include one or more of; resistance to organic solvents, detergents, proteolytic enzymes, extremes of temperatures and/or pH. A potential advantage of a relatively strong bond between plugs 1204 and the opening of chambers 1202 (e.g., strepavidin-biotin bond) is to seal and/or arrest (a) liquid and/or (b) cells (e.g., sperm cells) inside chambers 1202, such as for correspondingly (a) minimizing liquid evaporation and/or diffusion of molecules from one chamber to another chamber and (b) transportation over relatively long distance and/or relatively long periods of time and/or relatively harsh environmental conditions.

FIG. 2E illustrates an array 1214 of chambers 1216 with spaces in between chambers 1216, for example, as described with reference to FIG. 8A. Plugs 1204 can also be used with chambers 1216 of array 1214 as described herein.

### Insertion And/Or Removal of Plugs

FIG. 2F illustrates an array of chambers, for example, as illustrated in FIG. 2D or 2E, where an external force is applied to attract plugs 1204 to the opening of chambers 1202, in accordance with some embodiments of the invention. Optionally, the external force is applied to maintain plugs 1204 in position at the opening of chambers 1202. Alternatively or additionally, the external force is applied to remove plugs 1204 from the opening of chambers 1202, for example, to provide access to the contents of the chambers.

In some embodiments of the invention, the external force is remotely applied by a first source of applied force, for example, by a first magnet 1218 creating a magnetic field. Optionally, magnet 1218 is a permanent magnet. Alternatively, magnet 1218 is an electromagnet that can be turned on or off, and/or having adjustable strength. Optionally, magnet 1218 is located relatively below chambers 1202.

In some embodiments of the invention magnet 1218 is used to ‘pull’ plugs 1204 with paramagnetic properties to the opening of chambers 1202. The direction of the applied force by magnet 1218 on plug 1204 with paramagnetic properties is towards magnet 1218.

In some embodiments of the invention, a magnet can be used to remove plugs 1204 from position in chambers 1202, for example, by applying the magnetic field from relatively above plugs 1204, such as by magnet 1220. The magnet can be used to remove plus from most of the chambers (e.g., all the chambers). Alternatively, a relatively small magnet that is finely directed (e.g., placed at the end of a thin probe) can be used to selectively remove plugs from one or more chamber at a time. The direction of the applied force by magnet 1220 on plug 1204 with paramagnetic properties is towards magnet 1220. Alternatively or additionally, magnet 1218 (e.g., located below chambers 1202) can be used to remove plugs by having a direction of the applied force by magnet 1218 on plug 1204 that is away from magnet 1218, for example, the polarity of magnet 1218 can be reversed by reversing the current through magnet 1218 (e.g., electromagnet), flipping magnet 1218 upside down, and/or replacing magnet 1218 with another magnet having the desired magnetic field. Alternatively or additionally, magnet 1220 can be used to insert plugs 1202 into chambers 1202, for example, by having a direction of the applied force away from magnet 1220. Plugs 1202 can be ‘pushed’ into chambers 1202.

In some embodiments of the invention, the external force is remotely applied by an electrical field, for example dielectrophoresis, such to insert plugs 1204 into chambers 1202 and/or remove plugs 1204 from chambers 1202 such as by moving plugs 1204 through the solution covering chambers 1202.

In some embodiments of the invention, the plugs are made out of a dielectric material (e.g., glass, plastic).

In some embodiments of the invention, a non-uniform electrical field is applied to the plug/chamber set-up to insert plugs 1204 into chambers 1202. The electrical field is relatively denser at the opening of chamber 1202, decreasing in strength relatively away from chamber 1202. The gradient of the electrical field can result in plug 1204 being attracted to the relatively denser electrical field, thereby causing plug 1204 to move and plug chamber 1202. Alternatively, a non-uniform electric field is applied to remove plug 1204 from chambers 1202. The electrical field in such a situation would be relatively less dense at the opening of chamber 1202, and increasing in strength away from chamber 1202. The gradient of such an electrical field can result in plug 1204 being attracted away from the chamber 1202 by the gradient of the non-uniform electrical field.

In some embodiments of the invention, the non-uniform electrical field is created by electrodes having relatively different surface areas. The electrical field density increases from the relatively larger electrode to the relatively smaller electrode. For example, to plug chambers 1202, the following set up can be used; a first electrode having a surface area less than the opening area of chamber 1202 placed below chambers 1202, and a second electrode having a relatively larger surface area than the first electrode (e.g., about 200% larger, about 500%, about 1000%, about 10000% or other smaller, intermediate or larger sizes) is placed above chamber 1202. For example, to remove plug 1204 from chamber 1202, the locations of the electrodes can be reversed.

In some embodiments of the invention, an alternating current is used to power the non-uniform electrical field, for example, by using a wall outlet as the power supply. A potential advantage of using the alternating current is to prevent and/or reduce ionization of the solution of chambers 1202 and/or prevent deposition of ions dissolved in the solution on the electrodes. The net force moving the plug is related to the square of the electrical field density, therefore an alternating current can result in the net movement of plug 1204.

In some embodiments of the invention, plugs 1204 are inserted into chambers 1202 by vibrating chambers 1202. Non-limiting advantages of vibrations include; shake plugs 1204 into position at the opening of chambers 1202; shake plugs 1204 to fall into chambers; shake plugs 1204 around, potentially causing only those plugs 1204 that are well placed at the opening of chambers 1202 to remain. The vibrations can continue, until a significant number of plugs 1204 have settled into the chamber 1202 openings and/or have fallen into chambers 1202. Non-limiting examples of vibration include; 1 Hz, 5 Hz, 10 Hz, or other smaller, intermediate or larger values. Non-limiting examples of the amplitude of direction of vibration include; about 50% of the diameter of chamber 1202, about 100% of the diameter, about 500% of the diameter, or other smaller, intermediate or larger values are used. Vibrations can occur in one dimension only, in two or more dimensions, or can be omni-directional.

In some embodiments, plugs 1204 are removed from chambers 1202 by applying an adhesive to the side of plugs 1204 not covering chambers, and removing the adhesive together with the plugs 1204. A non-limiting example includes rolling a ball coated with the adhesive over the chamber array.

### Plug And Cover Combination

In some embodiments of the invention, a combination of plugs and one or more covers is used, for example, plugs are inserted into the openings of the chambers as described herein, followed by the application of one or more covers. The cover can also be applied to the unplugged chambers (e.g., if there are some chambers that are covered and some chambers that are uncovered). Alternatively, plugs and covers can be applied in any order, for example, the reverse, such the cover, followed by the plugs, optionally followed by one or more covers. A non-limiting example of the combination of plugs and cover includes; plugs as described herein (e.g., glass and/or PDMS beads), and the cover comprising a relatively thin and/or flexible film (e.g., plastic-wrap). Optionally, a liquid such as a transparent liquid (e.g., water, oil) is applied over the plug/cover combination. A potential advantage of the liquid is relatively improved sealing of the chambers, for example, the weight of the liquid can cause the flexible cover to be pushed into the openings of the chambers and/or onto the plug (e.g., around the plug to seal the opening). Alternatively or additionally, air pressure and/or vacuum can be used in combination with the plug and cover, and optional liquid. A potential advantage of vacuum and/or air pressure is relatively improved sealing, for example, acting as a force to seal the chambers with the cover and/or plugs.

In some embodiments of the invention, the combination of plug/cover is used to arrest cells (e.g., ‘floating’ cells such as oocytes and/or adipocytes and/or ‘swimming’ cells such as sperm cells) in the chambers. A non-limiting method includes; covering the chamber (having a solution therein) with oil, for example as described with reference to 504 (FIG. 5); inserting the cell into the chamber through the oil, for example as described with reference to 506 (FIG. 5); and plugging the chamber with a plug, for example, as described herein. A potential advantage is preventing the cells from floating and/or swimming away.

In some embodiments of the invention, the combination of plug/cover is used to remove plugs from chambers, while preventing cells from escaping (e.g., floating and/or swimming cells). A non-limiting method includes; applying oil over the chamber/plug; and removing the plug (through the oil), for example, as described herein. A potential advantage is preventing the cells from floating and/or swimming away.

FIG. 2G illustrates the use of a plug (e.g., cushion plug 1232) to close off two or more chambers 1202 (e.g., adjacent chambers), in accordance with an exemplary embodiment of the invention.

In some embodiments of the invention, plug 1232 is used to close off the chamber array having chambers 1202 relatively close together, for example, array 1200 (e.g., as in FIG. 2D). Alternatively or additionally, plug 1232 can be used to close off the chamber array having chambers 1216 relatively far apart, for example, array 1214 (e.g., as in FIG. 2E).

In some embodiments of the invention, plug 1232 is relatively larger than plug 1204, for example, plug 1232 has dimensions sufficiently large to close off two or more adjacent chambers 1202.

In some embodiments of the invention, plug 1232 is made out of a material having sufficient flexibility to fully or partially enter the opening of chambers 1202, for example, plastic and/or silicon wrap.

In some embodiments of the invention, a force 1234 is applied to plug 1232. Optionally, force 1234 is applied to push plug 1232 into position at the opening of chambers 1202. Alternatively or additionally, force 1234 is applied to maintain plug 1232 in position at the opening of chambers 1202.

In some embodiments of the invention, force 1234 is applied by the weight of cover 1230 (e.g., gravity). Alternatively, force 1234 can be applied in other ways, non-limiting examples include liquid, physically applied manual pressure, air pressure and/or vacuum, for example as described with reference to box 158 of FIG. 1C and/or the in paragraph above.

### Alternative Method

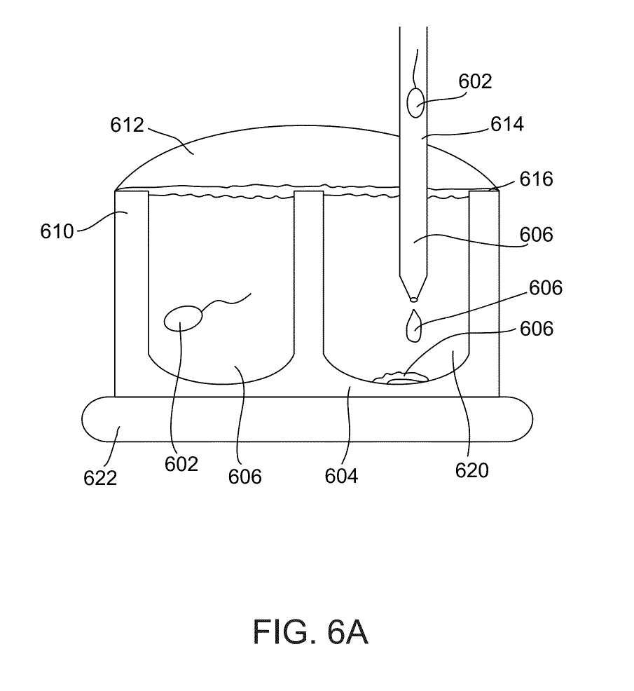

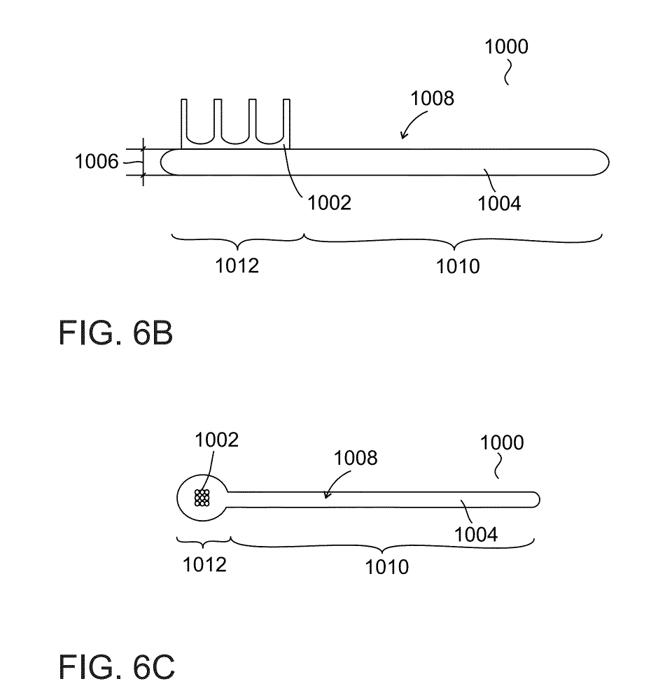

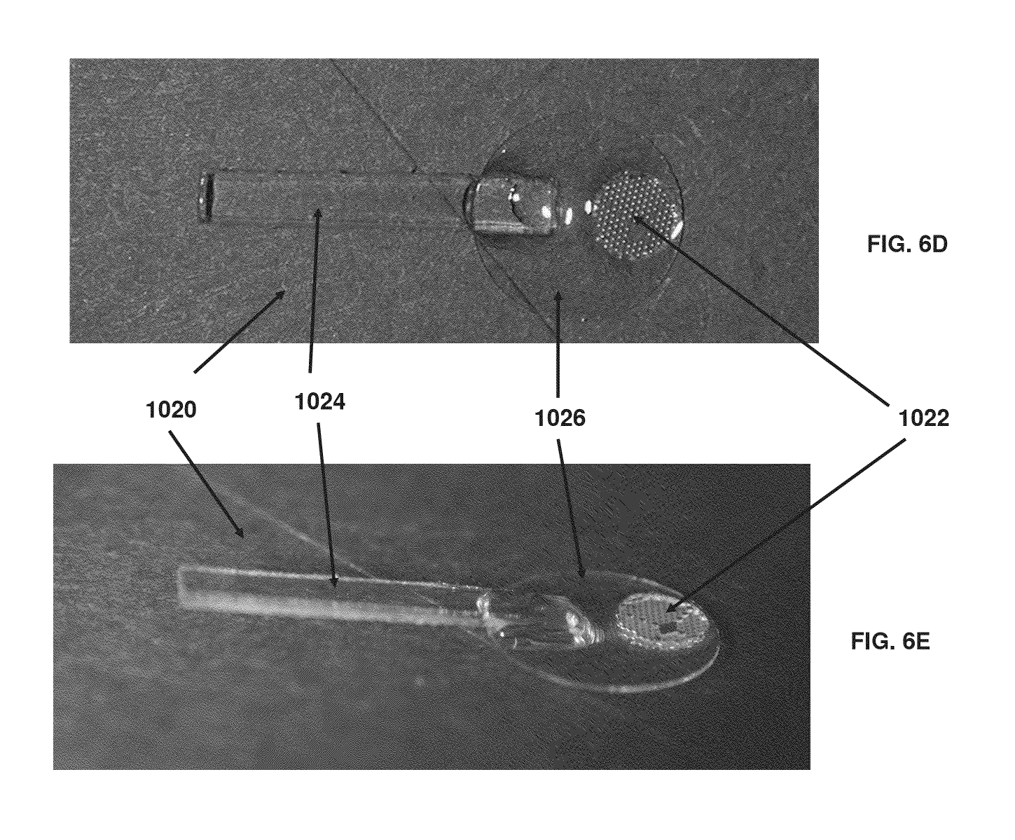

FIG. 5 illustrates an alternative method of arresting cells in a chamber array, in accordance with some embodiments of the invention. For illustrative purposes, reference will be made to FIG. 6A, which is an illustration showing cells arrested inside a chamber array.

At 504, a fluid 612 and/or a film 616 is applied over chambers 604, to acts as a cover for chambers 604, for example, as described with reference to FIG. 2B and/or 2C, and/or box 204 in FIG. 2A.

In some embodiments, fluid 612 and/or film 616 traps air 620 inside chambers 604.

In some embodiments, fluid 612 is oil.

In some embodiments, fluid 612 is applied manually and/or automatically, such as by common pipette.

In some embodiments, film 616 is relatively thin, for example, having a thickness of several hundred angstroms (eg. molecular thickness).

In some embodiments, film 616 is a polymer, for example, Formvar Resin available from SPI supplies. Formvar is applied as a drop, which then spreads out over a surface (eg. solution 606 inside chambers). The liquid portion of Formvar evaporates, leaving behind a polymer film.

At 506, cells 602 are inserted into chambers 604, in accordance with some embodiments of the invention. Optionally, cells 602 are inserted into chambers 604 together with solution 606 such as physiological solution with nutrients. Optionally, air 620 is removed from chambers 604, for example, air is pushed out by solution 606 entering chamber 604.

In some embodiments, chambers 604 are filled with enough solution 606 to support one or more cells 602, depending on the experimental conditions. Optionally, the level of solution 606 in at least some chambers 604 is about the level of the top of walls 610. Alternatively or additionally, the level of solution 606 in at least some chambers 604 is less than the level of the top of walls 610.

In some embodiments, cells 602 are removed from chambers 604.

In some embodiments, cells 602 are manipulated while inside cells 604.

In some embodiments, cells 602 are inserted with solution 606 in chamber 604 by injection, such as using a micropipette 614 and/or a microinjector. Chamber 604 on the right side of FIG. 6 illustrates pipette 614 piercing through the top layer of fluid 612 and/or film 616, into an empty chamber 604 containing air 620. Cell 602 is injected with solution 606 into chamber 604 to fill chamber 604 with fluid 606. Pipette 614 is then removed, the hole behind being filled in by fluid 612 and/or film 616, resulting in cell 602 being isolated in chamber 604.

In some embodiments, fluid 606 may not only fill chambers 604 but also the space above the array. In such a case, after the introduction of fluid 612 and/or film 616 on top of the droplet solution 606, the excess can be pumped out, causing the lower surface of fluid 612 and or film 616 to lower down until reaching the level of the top of walls 610. The actual pumping or removing of excess of fluid 606 can be done via a micropipette or a microsyringe which reaches the fluid 606 via fluid 612.

It should be noted that other particles (eg. non-living) can be arrested in chambers 604 by the discussed method.

In some embodiments, a base 622 supports chambers 604. Optionally, base 622 is used to remove excess solution 606 (eg. over filling), for example, as described with reference to FIGS. 2B and 2C.

### Embodiment of Device For Long Term Storage

FIG. 6B is a side view (magnified) and FIG. 6C is a top view of a device 1000 with a chamber array 1002 designed for cryopreservation of cells, in accordance with some embodiments of the invention.

In some embodiments of the invention, array 1002 is coupled to a support 1004, for example, one or more of, printed on to support 1004, glued, crimped.

In some embodiments of the invention, at least some area of support 1004 contains a material to absorb excess solution, for example, as described with reference to FIGS. 2B and 2C.

In some embodiments of the invention, array 1002 is relatively small, for example, having a size of 3×3 chambers, 5×5 chambers, 10×10 chambers, 100×100 chambers, 1000×1000 chambers, 10000×10000 chambers or other smaller, intermediate or larger sizes. A potential advantage of a relatively small array is relatively increasing the ease and/or speed of locating cells in the array. As only a relatively small number of cells (eg. sperm, oocytes) are available and/or required, the array does not have to be very large.

In some embodiments of the invention, support 1004 is designed for relatively low heat capacity. Optionally, support 1004 has a low mass, for example, a thickness 1006 of about 100 micrometers, or 50 micrometers, or 500 micrometers, or other smaller, intermediate or larger thicknesses. Alternatively or additionally, support 1004 is made out of a material with a relatively low thermal mass such as conductive glass. Alternatively or additionally, a surface area 1008 of support 1004 is relatively small, for example, 5 square millimeters, 10 square mm, 100 sq mm, 1000 sq mm, or other smaller, intermediate or larger values.

In some embodiments of the invention, chambers in array 1002 are cooled separately. Optionally, chambers are separated from one another by a space. In some embodiments, cold air and/or other fluid circulates in the spaces between the chambers. A potential advantage is that there is better control of the cooling rate and/or of the cooling locations, for example, all or most of chambers are cooled at once, leaving no time for crystals to form inside the cells and/or in the solution.

In some embodiments of the invention, support 1004 has a holding region 1010, and/or an array 1002 region 1012, for example, shaped like a pan and/or tennis racquet. Alternatively, support 1004 is shaped like a straw.

In some embodiments, array region 1012 is relatively small, for example, having an area of 1 mm×1 mm, or 3 mm×3 mm, or 5 mm×5 mm, or other smaller, intermediate or larger dimensions.

A potential advantage of device 1000 is convenience when moving from location to location, for example one or more of, a loading region, a microscope bench, an incubator, a deep freezer (eg. −90° C.), an environment of liquid nitrogen, directly immersing array 1002 into liquid nitrogen (eg. −195.65° C.), first flooding the device by liquid nitrogen for immediate sample freezing and then moving it to the deep freeze environment.

In some embodiments of the invention, holding region 1010 is for example, one or more of, glass, polymer, metal, a wire (eg. conducting and/or insulating), sewing thread, dental floss.

In some embodiments of the invention, support 1004 is made out of a material with relatively high thermal conductivity (eg. conductor), such as copper and/or silver. Optionally or additionally, the material is relatively thin, to relatively improve thermal conduction. Optionally or additionally, the material is transparent, for example indium tin oxide, and/or a film of indium tin oxide. Optionally, support 1004 is made out of a biocompatible material.

In some embodiments of the invention support 1004 (or at least some portion thereof) is at least transparent. Alternatively or additionally, support 1004 is opaque.

FIG. 6D is an image showing a top view and FIG. 6F is an image showing a side view of an exemplary cryopreservation apparatus 1020, such as device 1000, useful for practicing some embodiments of the invention. Apparatus 1020 has been successfully used to perform experiments in accordance with exemplary embodiments of the invention.

In the embodiment shown in the images, device 1020 comprises a handle 1024, such as holding region 1020. At one end, handle 1024 is attached to an array region 1026 such as region 1012, having a diameter of about 8 mm. A chamber array 1022, such as array 1002, has been made by embossing an area having a diameter of approximately 4 mm on array region 1026.

In the embodiment shown in the images, the entire device 1020 is made out of glass.

### Alternative Device And Method of Use

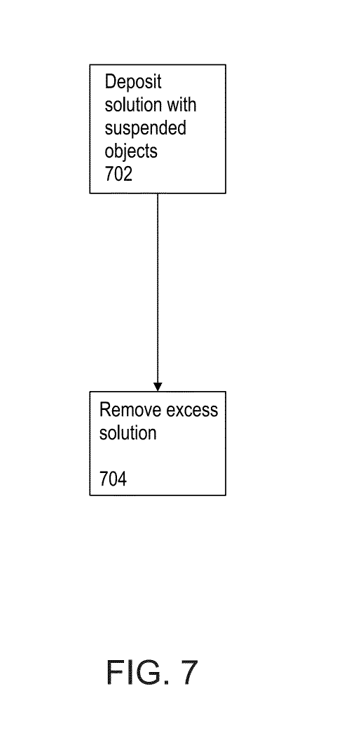

FIG. 7 is a method of arresting objects suspended in a solution (eg. compounds for chemical reactions and/or cells), using an embodiment of a chamber array device 800 illustrated in FIGS. 8A-C, in accordance with some embodiments of the invention.

FIG. 8A illustrates chamber device 800 comprised of one or more chambers 804, such as in the form of tubes, for example, hollow cylinders or ‘doughnut’ shaped. Alternatively, at least some of the chambers have other shapes, not necessarily limiting examples include; square, hexagonal. Optionally, chambers 804 are coupled to a base 830.

In some embodiments, an internal diameter 820 of chambers 820 is, for example, about 1 μm, about 5 μm, about 10 μm, about 25 μm, about 50 μm, about 75 μm, about 100 μm, about 150 micrometers, about 250 micrometers, about 350 micrometers, about 0.5 mm, about 1 mm, about 2 mm, or other smaller, intermediate or larger diameters. Alternatively, diameter is similar to the diameter of a chamber.

In some embodiments, an external diameter 822 of chambers 820 is, for example, about 5 μm, about 10 μm, about 25 μm, about 50 μm, about 75 μm, about 100 μm, about 150 μm, about 200 micrometers, about 300 micrometers, about 400 micrometers, about 0.5 mm, about 1 mm, about 2 mm, or other smaller, intermediate or larger diameters.

In some embodiments, a height 828 of chambers 820 is, for example, about 0.8 μm, about 1.1 μm, about 1.5 μm, about 5 μm, about 10 μm, about 25 μm, about 50 micrometers, about 100 micrometers, about 130 micrometers, about 200 micrometers, about 0.5 mm, about 1 mm, about 2 mm, or other smaller, intermediate or larger heights. Alternatively, height 828 to diameter 820 ratio is about 1:1, or about 1.2:1, or about 1.5:1, or about 1.75:1, or about 2:1, or about 3:1, or about 4:1, or about 5:1, or about 0.75:1, or about 0.5:1, or about 0.3:1, or other smaller, intermediate or larger values are used.

Potentially, chamber 820 volumes on the order of picoliters are suitable for studying relatively large objects such as sperm cells. Potentially, chamber 820 volumes on the order of femtoliters are suitable for studying relatively small objects, such as molecular chemical reactions.

In an exemplary embodiment of the invention, chambers 820 are manufactured using any suitable manufacturing process. Not necessarily limiting examples include photomicrolithographic techniques, embossing techniques. Further details can be found, for example, in US application No. 20060240548, 20080063572, and/or 20110275543 by DEUTSCH; Mordechai et al., incorporated herein in their entirety. Some not necessarily limiting examples of suitable materials include; SU8-5 resist, polystyrene, polypropylene, polycarbonate, cycloolefin copolymer, cycloolefin polymer, polymethylmethacrylate, UV curable polymers (urethane-methacrylates), or any other polymers suitable for molding for medical device applications.

In some embodiments, a gap 824 between chambers 820 is sufficiently large to reduce and/or prevent arresting a solution in gap 824, for example, about 5 μm, about 10 μm, about 25 μm, about 50 μm, about 75 μm, about 100 μm, about 150 μm, about 200 micrometers, about 300 micrometers, about 400 micrometers, or other smaller, intermediate or larger values. Alternatively or additionally, gap 824 is sized according to external diameter 822, for example, gap 824 is about 100% of external diameter 822, or about 200%, about 150%, about 120%, about 80%, about 50%, or other smaller, intermediate or larger dimensions are used.

In some embodiments, chambers 820 are shaped like a cylinder in order to reduce a surface area contacting the solution in gap 824. A potential advantage is reducing and/or preventing solution from sticking to chambers 820 in gap 824, such as by surface tension forces.

In some embodiments, an outside surface of chambers 820 is hydrophobic (eg. coated).

In some embodiments of the invention, chambers 820 are used as liquid arrays, columns of liquid that are separated by air gaps.

FIGS. 8D-8G are SEM (scanning electron microscope) images of an exemplary design of “doughnut-like” chambers (e.g., chamber 804), useful for practicing some embodiments of the invention. FIG. 8D is a top view, FIG. 8E is an isometric view, FIG. 8F is a non-cross-sectional side view, and FIG. 8G is an isometric view of an array of the chambers, The diameter of the chambers is about 150 micrometers, the height of the chambers is about 160 micrometers, and the wall thickness of the chambers is about 49 micrometers. The distance between the chambers is about 200 micrometers.

The array of chambers illustrated in the images has been used successfully to perform experiments in accordance with exemplary embodiments of the invention.

At 702, a solution having suspended particles to be studied is deposited over chamber device 800, as shown in FIG. 8B, in accordance with some embodiments of the invention.

In some embodiments (eg. forming a liquid array), solution 806 is flooded over chambers 804, for example, the volume of solution 806 used is relatively larger than the total volume of chambers 804, resulting in excess solution 806 outside (eg. around, above) of chambers 804.

In some embodiments, at least some objects 802 are located inside chambers 804, for example, objects 802 may enter through diffusion and/or random motion. In some embodiments, objects 802 are deposited together with solution 806 directly into respective chambers 802 (eg. by a pipette), for example, as illustrated in FIG. 8C.

FIG. 8H is a transmitted light image of a top view of an array of chambers of FIG. 8E, after applying a solution containing MOLT 4 cells (Human acute lymphoblastic leukemia cell line) over the chambers on of the array such as in 702, useful in practicing some embodiments of the invention. The MOLT 4 cells can be seen both within the chambers and between the chambers.

Optionally, at 704, the excess solution 806 is removed from around chambers 804. Optionally, excess solution 806 is reduced to a level below height 824. In some embodiments, the cylinder shape and/or hydrophilic coating of chambers 804 reduce and/or prevent excess solution 806 in gap 824, at least to the level below height 824.

In some embodiments, excess solution 806 is removed by one or more methods, for example, using base 830 as described with reference to FIGS. 2B and/or 2C.

In some embodiments, objects 802 are arrested in chambers 804.

Chambers 804 are not in fluid communication between one another, because gap 824 is sufficiently large to prevent and/or reduce solution 806 being trapped (eg. by capillary action and/or surface tension) between chambers 804.

FIG. 8I is an image of the array of FIG. 8H, after removing the excess solution/suspension, such as in 704, useful in practicing some embodiments of the invention. MOLT 4 cells previously located in between the chambers have disappeared, while those cells previously located inside the chambers remained inside the chambers.

FIG. 8J is an image of an exemplary device 1030 used to successfully perform the experiment of FIGS. 8I and 8H, useful for practicing some embodiments of the invention. Device 1030 is similar to device 1000 illustrated in FIGS. 6B and 6C, but having an array of chambers 1032 as described with reference to FIG. 8A. An array handle 1030A (e.g., similar to holding region 1010) is made out of a heat conducting material and/or handle 1030A is designed to conduct heat from one end to the other end. A potential advantage is to efficiently conduct heat away from chambers 1032, thereby relatively improve the cryopreservation process.

### Additional Examples of Chamber Embodiments

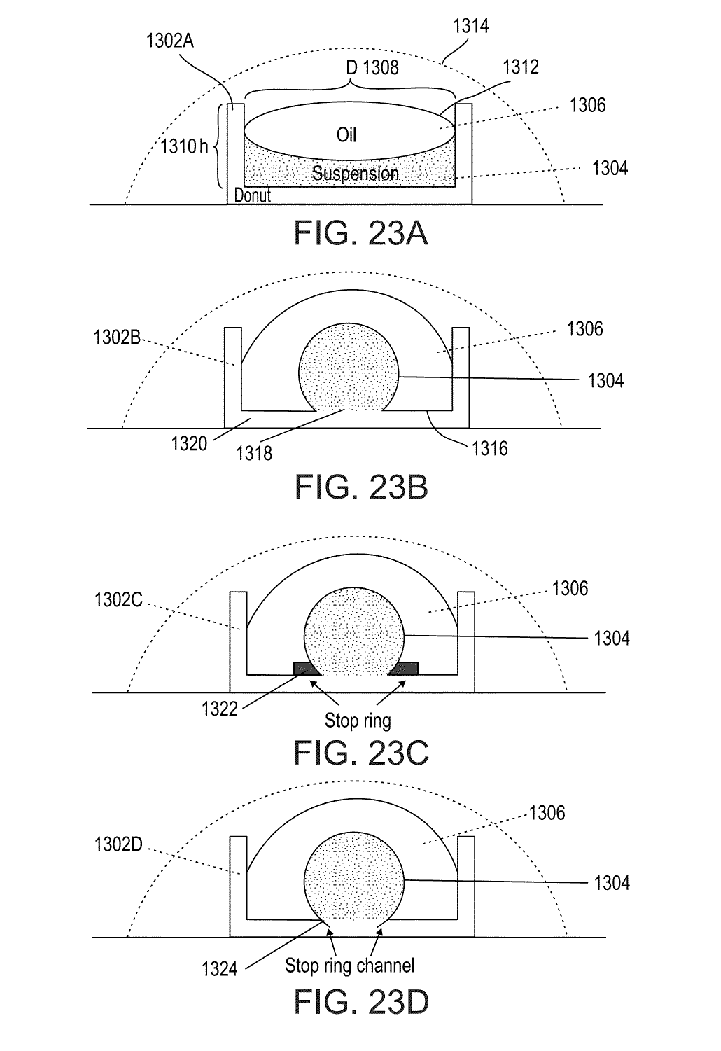

FIGS. 23A-D illustrate some additional examples of chamber embodiments, in accordance with an exemplary embodiment of the invention. In an exemplary embodiment of the invention, chambers 1302A-D are the same as, for example, described with reference to FIGS. 8A-I. Optionally or additionally, chambers 1302A-D are positioned for use on a cryopreservation device, for example, as described with reference to FIGS. 6B-C.

In an exemplary embodiment of the invention, the volume of chambers 1302A-D is for example, about 0-3 μL (microliters), or about 0.5 μL-3 μL or about 0.5 μL-2.5 μL, or about 0.75 μL-1.5 μL, or about 1 μL, or other smaller, intermediate or larger ranges are used.

In an exemplary embodiment of the invention, chambers 1302A-D are substantially cylindrical, having a diameter 1308 and a height 1310. The ratio between height 1310 and diameter 1308 is for example, about 1:1, 1.25:1, 1.5:1, 1.75:1, 2:1, 2.5:1, 3:1, 0.75:1, 0.5:1, 0.33:1, or other smaller, intermediate or larger values are used. Alternatively, chambers 1302A-D are substantially rectangular, having dimension ratios of length:width of, for example, about 1:1, 1.25:1, 1.5:1, 1.75:1, 2:1, 2.5:1, 3:1, 0.75:1, 0.5:1, 0.33:1, or other smaller, intermediate or larger values are used. The ratios of height to length and/or width is for example, 1:1, 1.25:1, 1.5:1, 1.75:1, 2:1, 2.5:1, 3:1, 0.75:1, 0.5:1, 0.33:1, or other smaller, intermediate or larger values are used. The wall thickness is for example, about 5% of the diameter of the chamber, or about 10%, about 20%, about 30%, about 40%, about 50%, or other smaller, intermediate or larger diameters.

In an exemplary embodiment of the invention, the walls of at least some of the chambers are not tapered. Alternatively or additionally, the walls of at least some of the chamber are tapered, for example, reverse tapering.

In an exemplary embodiment of the invention, there are 1 chambers 1302A-D, or 2, 9, 20, 50, 100, 1000 or other smaller, intermediate or larger number of chambers 1302A-D are used. Optionally, the chambers are arranged in an array, for example, a grid or checkerboard pattern.

In an exemplary embodiment of the invention, chambers are selected are selected according to a desired freezing speed. For example, some chambers are designed for slower freezing, and others for faster freezing.

FIG. 23A illustrates chamber 1302A for arresting at least one object (e.g., sperm cells, adipocytes, ovum) in a suspension 1304. Optionally, suspension 1304 is covered by a cover 1306 contained within a cavity 1312 of chamber 1302A, for example, oil, or other covers, for example as described herein. Alternatively, suspension is covered by an extended cover 1314 that encapsulates and/or extends over chamber 1302.

FIG. 23B illustrates chamber 1302B having at least a portion of an inner surface 1316 is coated with and/or made from a hydrophobic material. Optionally, at least a portion of an inner surface 1318 is not coated with the hydrophobic material, but optionally coated with a hydrophilic material, to attract the solution to the base of chamber and/or away from the walls, further assisting in arresting the solution inside the chamber.

In some embodiments, coated surface 1316 extends along at least a portion of surface of support 1320 along walls of chamber 1302B. Optionally or additionally, at least some of an interior of walls of chamber 1302B is coated with the hydrophobic material. In some embodiments, substantially a centre of support 1320 within chamber 1302B is uncoated or coated with the hydrophilic material. Potentially, the hydrophilic and/or hydrophobic material help in arresting suspension 1304 containing the object. Potentially, the hydrophobic coating prevents spread of suspension 1304, for example, suspension 1304 is shown as a sphere adhering to support 1320, optionally suspension 1304 is repelled from inner walls of chamber 1302B. Potentially, the formation of the sphere of suspension 1304 provides a sufficiently larger volume for cell movement. Potentially, the hydrophobic attracts the oil layer.

FIG. 23C illustrates chamber 1302C having one or more elevations 1322, for example, a ring shaped elevation, but other suitable shapes can be used, for example, squares. In some embodiments, elevation 1322 is disposed on support 1320, without touching walls of chamber 1302C. Alternatively, elevation 1322 extends to walls of chamber 1302C. Potentially, elevation 1322 assists in containing suspension 1304, for example, at least some of suspension 1304 residing in the space within ring shaped elevation 1322.

In some embodiments, a height of elevation 1322 is for example, from 1% to 50% of chamber height 1310, or about 5% to about 30%, or about 7% to about 15%, or other smaller, intermediate or larger sizes.

In some embodiments, at least some parts of elevation 1322 (e.g., top surface, outer walls) are coated with the hydrophobic coating. Optionally or additionally, at least some parts of elevation 1322 (e.g., internal walls) are coated with the hydrophilic coating.

FIG. 23D illustrates chamber 1302D having one or more channels or grooves 1324 within support 1320, for example, a ring shaped groove having a central elevation of support 1320. Alternatively, groove 1324 is a coin shaped depression having no central elevation. In some embodiments, groove 1324 is disposed at the interface of the hydrophilic or no coating and hydrophobic coated portions. Potentially, groove 1324 assists in containing suspension 1304, for example, preventing suspension 1304 from spreading further past groove 1324.

In some embodiments, a depth of groove 1324 is for example, from 1% to 50% of thickness of support 1320, or about 5% to about 30%, or about 7% to about 15%, or other smaller, intermediate or larger sizes.

### General

It is expected that during the life of a patent maturing from this application many relevant methods to arrest objects in chambers will be developed and the scope of the term method to arrest objects in chambers is intended to include all such new technologies a priori.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some features of some embodiments of the invention in a non limiting fashion. Embodiments can use features from example, without taking all of the features.

### Experiment: Use of A Cover Over A Chamber Array

Inventors performed a series of experiments using an exemplary embodiment of a method of the invention, to illustrate arresting fluorescent solution inside chambers using a rigid cover, such as to form a liquid array. The use of fluorescent solution is meant to be non-limiting, and serves as an example to other objects in solution, such as cells (eg. sperm, oocytes, adipocytes) and/or other compounds (eg. DNA).

### Materials

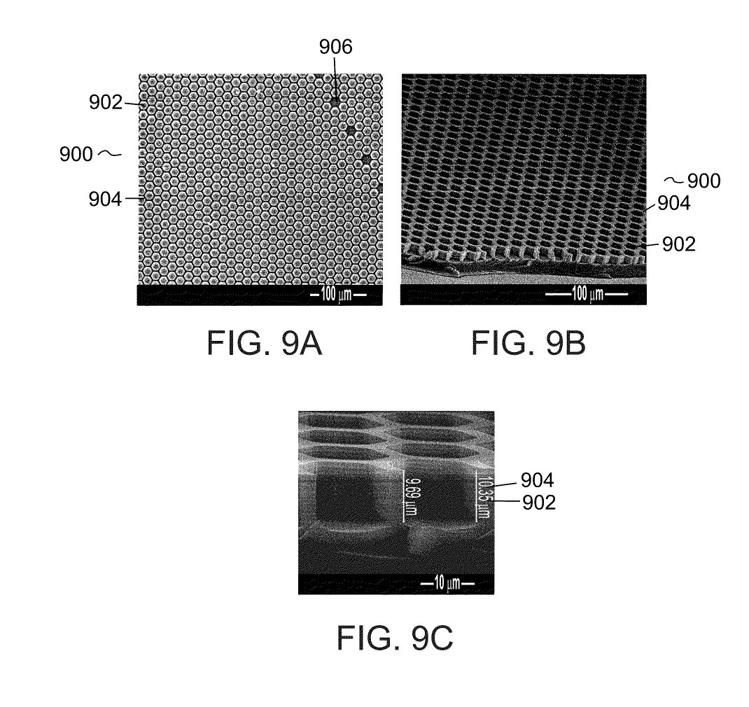

FIGS. 9A-9C are scanning microscope images of a sample chamber array 900 (eg. picowell array) used by the inventors to perform some of the experiments described below, in accordance with an exemplary embodiment of the invention.

FIG. 9A is an image of array 900 from above. FIGS. 9B and 9C are images of array 900 from the side at various magnification levels, illustrating chambers 902 surrounded by walls 904.

Markers 906 are shown in FIG. 9A. Markers 906 are areas without a chamber, having a height of walls 904.

### Method

5 microliters of fluorescent solution (50 micromolar fluorescein in double distillated water) was trapped inside chambers (eg. chambers 902), in accordance with an exemplary embodiment of the invention as described with reference to FIGS. 3A-D. Three experiments were performed in chambers having different depths, 8 micrometers, 12 micrometers and 100 micrometers.

For each sample, bright field microscopy (sample illuminated from below and viewed from above) and fluorescent images were acquired under the same conditions. The amplitude of the fluorescent signal was measured from the chambers, from the markers and/or the walls of the chambers.

For comparison purposes, measurements (bright field and fluorescent images) were also obtained using the 8 micrometer chamber array, before the excess solution was removed, to illustrate the results such as when the method according to an exemplary embodiment of the invention is not used.

The amplitude of the fluorescent signal was measured from just the solvent (double distillated water), with the same measurement setup (e.g. pouring the same volume of 5 microliters of water (without fluorescein), using the same chamber array, etc.) in order to serve as the background signal for the experiments, also referred to as “dark current”.

### Supporting Images

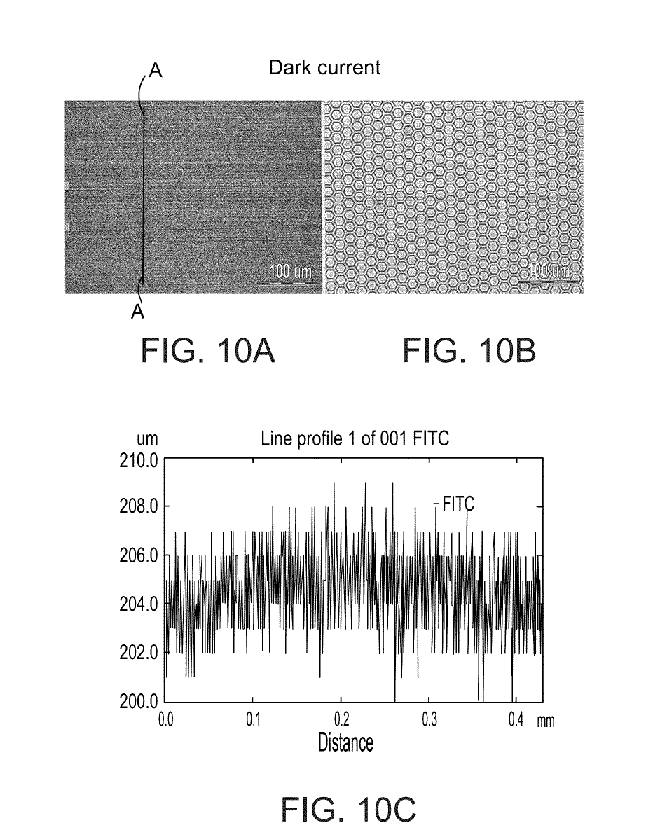

FIGS. 10A-C illustrate the control experiment (eg. measurement of the dark current). FIG. 10A is the image and/or signal obtained without fluorescein in water (eg. dark current), and FIG. 10B is the bright field image. FIG. 10C illustrates the intensity sampled along the profile line of the image obtained without fluorescein in solution (dark current), for example, taken along the profile line A-A of FIG. 10A, showing an average intensity value of 205+/−1.4 arbitrary units (au).

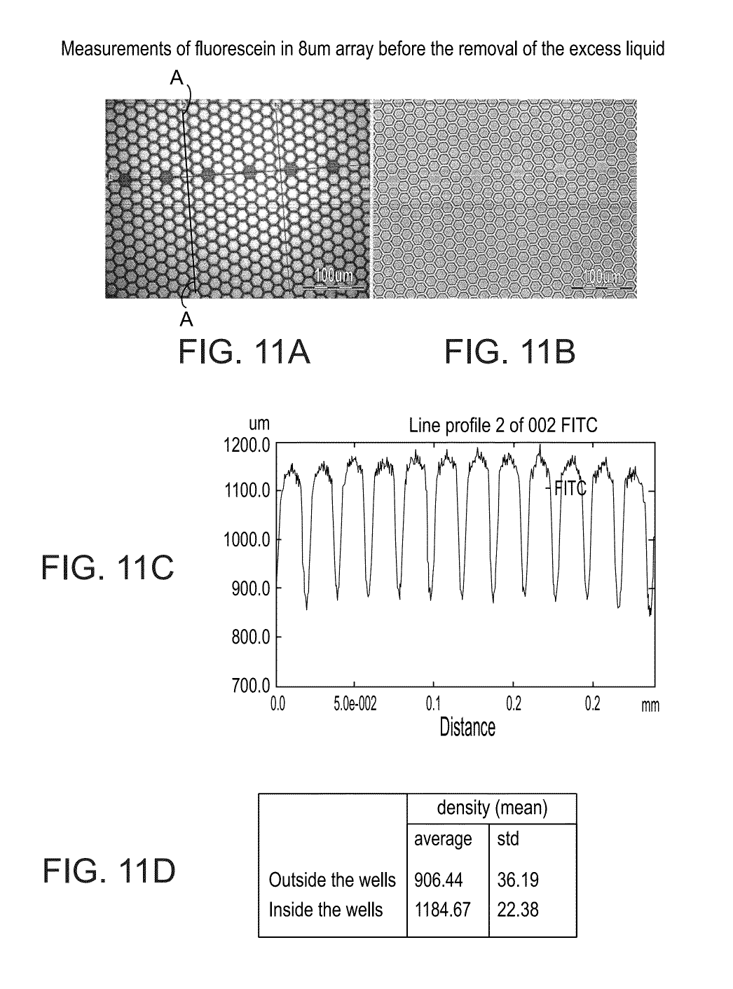

FIGS. 11A-D illustrate the results obtained with fluorescein solutions in chambers having depth of 8 micrometers. In these measurements excess liquid has not yet been removed. FIG. 11A is the fluorescent image, and FIG. 11B is the bright field image. FIG. 11C illustrates the fluorescence intensity (FI) measured along the profile line in the fluorescent image, for example, taken along line A-A of FIG. 11A, with a summary table in FIG. 11D. The summary table illustrates an average fluorescent amplitude value outside the chambers of 906.44 au, significantly higher than the dark current amplitude value of 205 au. Therefore, fluid is present outside of the chambers (eg. between chambers), such as on top of the chamber walls, resulting in fluid communication between chambers. Another reason for not disregarding this in-between chamber signal is the fact that it has the order of magnitude of that of the average FI measured from a chamber (˜1184 au).

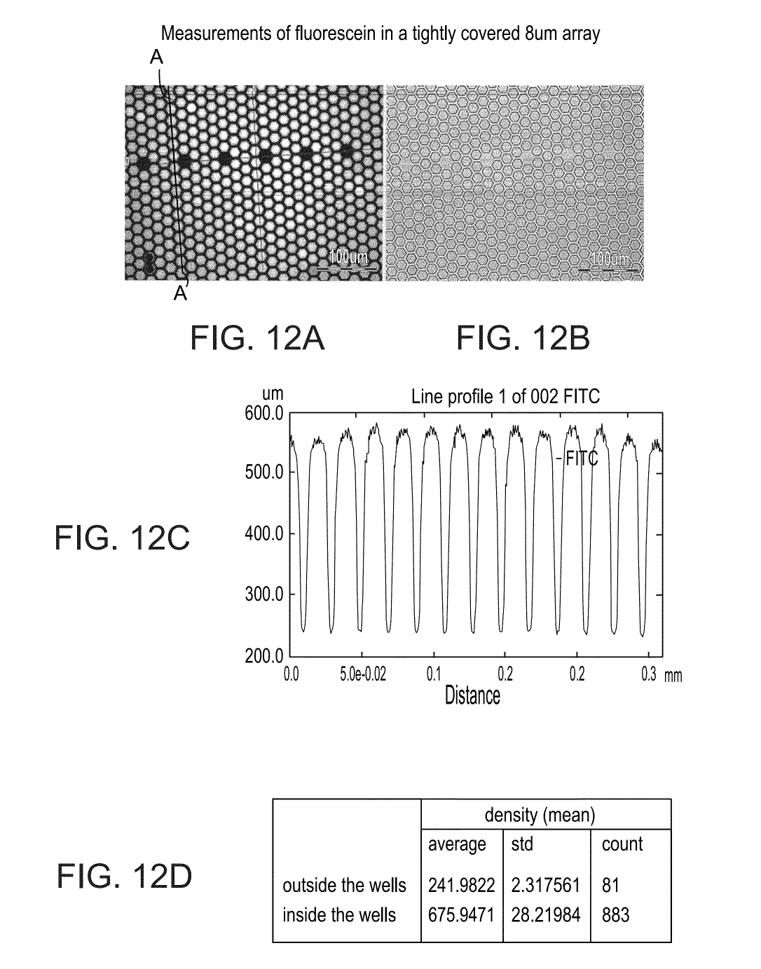

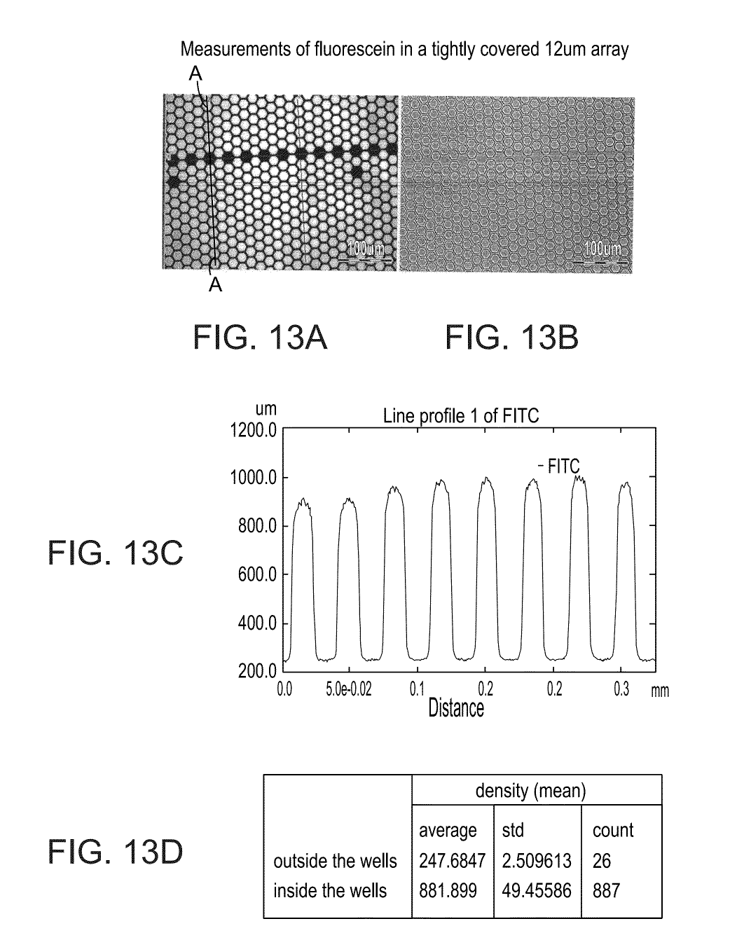

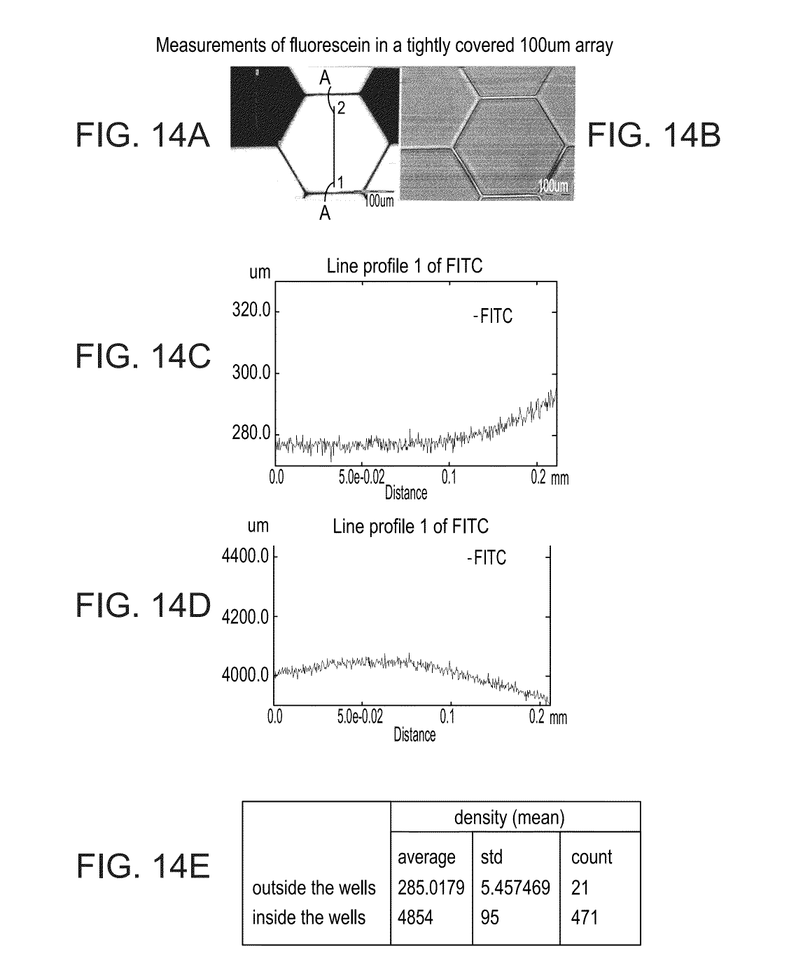

FIGS. 12A-D illustrate the experimental results using the 8 micrometer array, FIGS. 13A-D illustrate the results using the 12 micrometer array, and FIGS. 14A-E illustrate the results using the 100 micrometer array.

FIGS. 12A, 13A, and 14A are the corresponding fluorescent images, and FIGS. 12B, 13B and 14B are the corresponding bright field images.

FIGS. 12C, 13C, 14C and 14D are the corresponding light intensity profiles of the fluorescent images. The FI was measured for example along the respective profile lines labeled A-A in FIGS. 11A, 12A, 13A and 14A. Results are summaries in tables in FIGS. 12D, 13D and 14E.

The summary tables illustrate fluorescent amplitude value outside the chambers of 242 (for 8 micrometer chambers), 248 (for 12 micrometer chambers) and 285 (for 100 micrometer chambers), slightly higher than the dark current amplitude value of 205. The difference is believed to be non-significant, due to a possible error in not measuring the dark current amplitude value using the same glass cover. Therefore a non-significant amount of fluid is present outside the chambers, resulting in fluid isolation between chambers, in accordance with an exemplary embodiment of the invention.

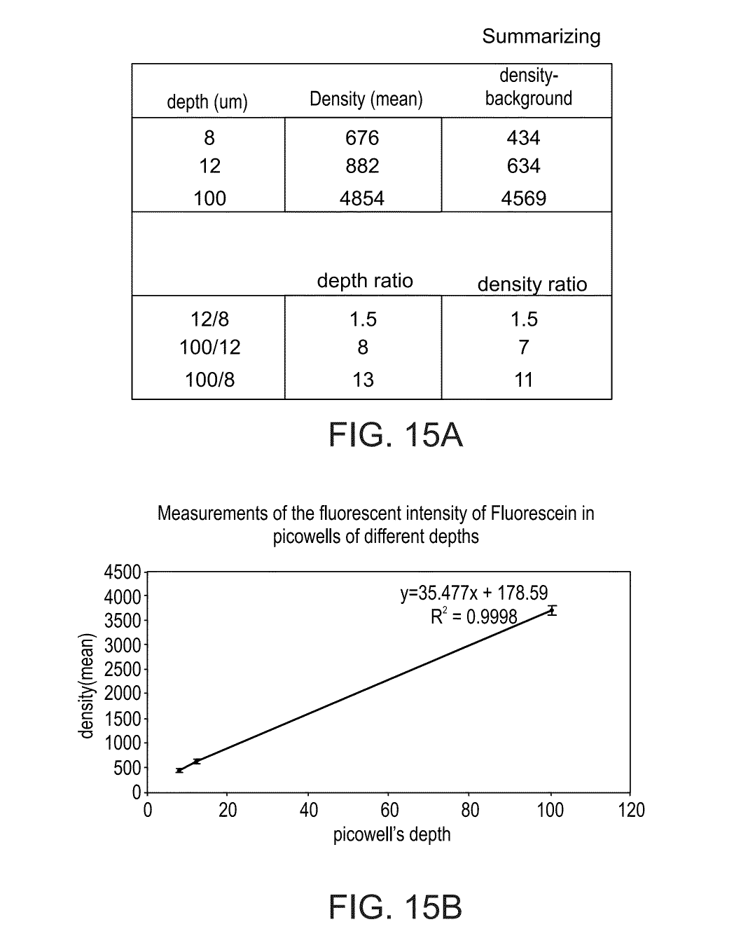

FIG. 15A is a table, and FIG. 15B is a chart illustrating the validity of the experimental method and results. The validation is based on the assumption that under the used fluorophor concentration and small absorption path length (depth of chamber), the FI is linearly related to the depth of the chambers.

Following the Beer-Lambert Law, this relation obeys the formula FI=QεCl, where Q is the light gathering power constant of the measuring system (in this case a microscope), ε is the molar (decadic) absorption coefficient, C is the fluorophor concentration and l is the absorption path length (thickness of the absorbing medium).

The top table of FIG. 15A is a summary of the measured fluorescent amplitude values (‘density(mean)’), and the absolute fluorescent values (absolute value=measured value minus dark current value) for the different chambers.

The bottom table of FIG. 15A illustrates the validity of the linear relationship, as the depth ratio is approximately equal to the ratio of measured fluorescent amplitude values (‘density’ ratio).

FIG. 15B is a plot of the mean fluorescent amplitude values as a function of the depth of the chambers (mean background density is defined as the mean measured density minus the black current value). An R square value of 0.9998 shows a high linear correlation value, indicating the validity of the experimental method.

### Results

The fluorescent signals from the markers of the different experiments using the different chamber arrays were not significantly different. T

he ratios of the average FI signals measured from the chambers with the different depths were found to be proportional to the ratio of their depths. Without being bound to theory, such a scenario occurs only if the chambers (having different depth) were fully filled, and the amount of fluorescent solution at the inter-chamber space (eg. walls of chambers) was relatively insignificant.

The results provide support that the methods described herein of arresting objects in chambers work for the range of chambers depths tested. Inventors believe that the results are non-limiting and that the methods described herein also work for chambers of sizes outside of the tested range.

The results also provide support that the method of arresting objects in chambers achieves fluid isolation between chambers.

The results also provide support that the method of arresting objects in chambers results in filling up most and/or all of the volume in the chambers with solution.

### Experiment: Use of Plugs With Chamber Array

Inventors performed experiments to illustrate arresting a fluorescent solution inside chambers using plugs, in accordance with an exemplary embodiment of the invention.

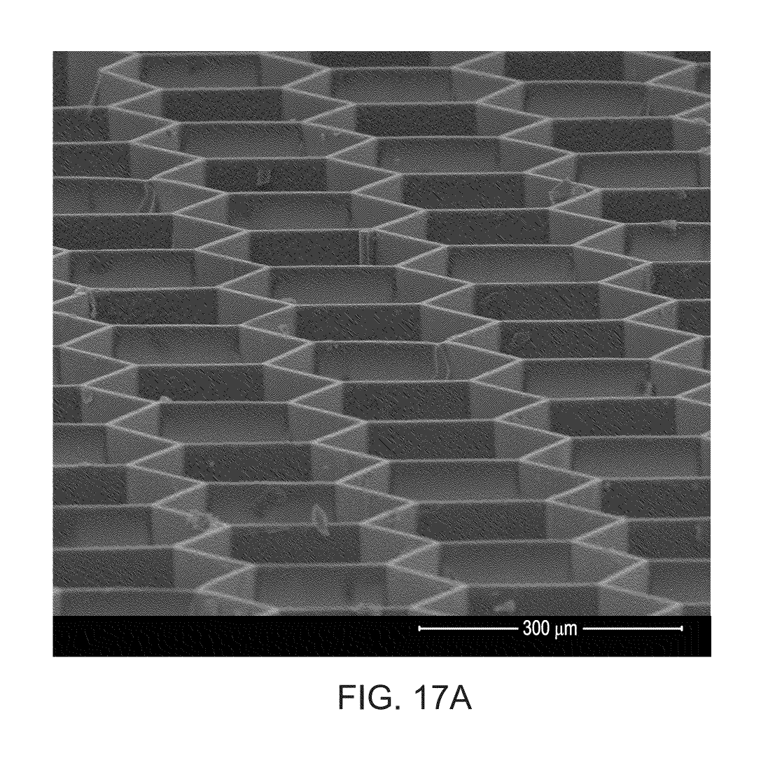

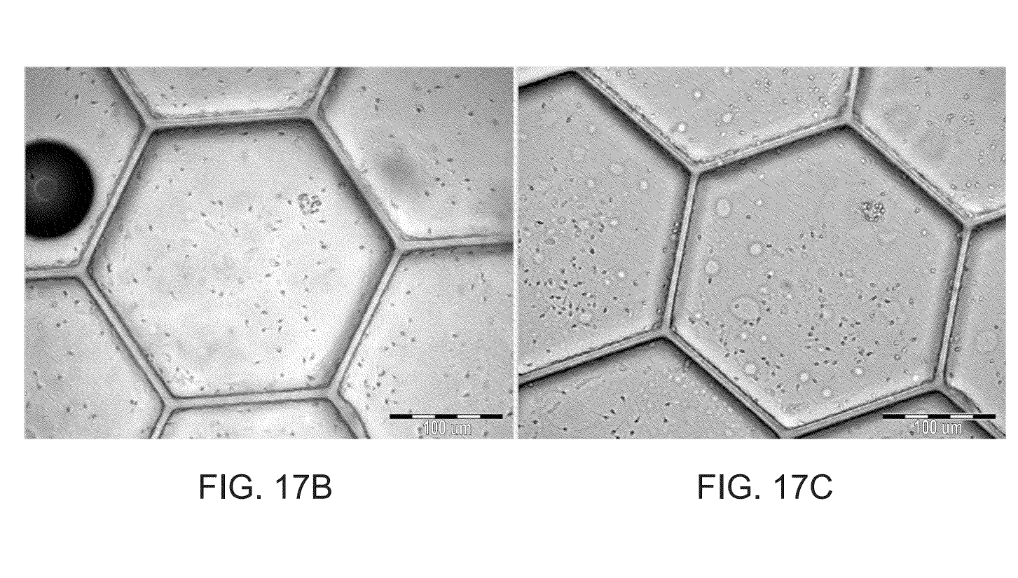

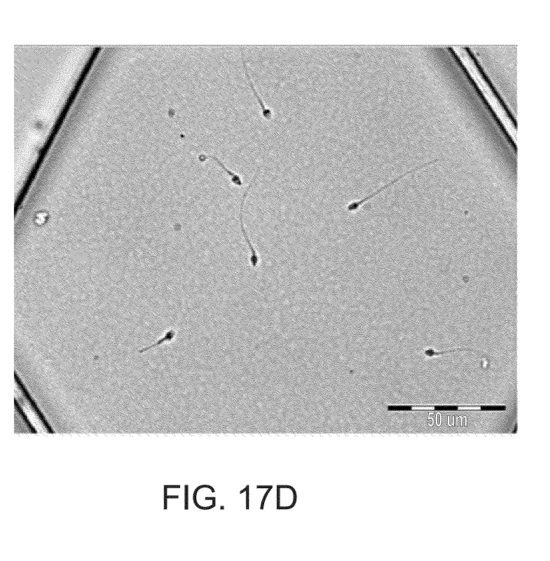

Materials: FIG. 17A is a scanning electron microscope image of an array of chambers (e.g., similar to array 100 of FIG. 1B) used to perform the experiment. The chambers had a depth of 130 micrometers, and an opening size of 250 micrometers.

The 25 μm (for single cells) and 250 μm (for sperm cryopreservation) diameter donuts are made from NOA81.

Fluorescein solution was used as the agent to be trapped inside the chamber.

Glass beads having diameters ranging from 150-250 micrometers were used as the plugs. The beads were hard (e.g., non-pliable) and non-porous. The size of the beads was selected to correspond to the opening size of the chamber array, beads having a diameter of about 250 micrometers were expected to plug the opening of the chamber.

Methods: Experimental procedure was based on the method as illustrated in FIG. 1C; The chamber array was first filled with fluorescein solution. The glass beads were then applied over the array. The fluorescein solution was washed with PBS. Bright field and fluorescent images were acquired and a horizontal fluorescence intensity profile was obtained (e.g., using techniques as described in the experiment ‘Use of a Cover Over a Chamber Array’).

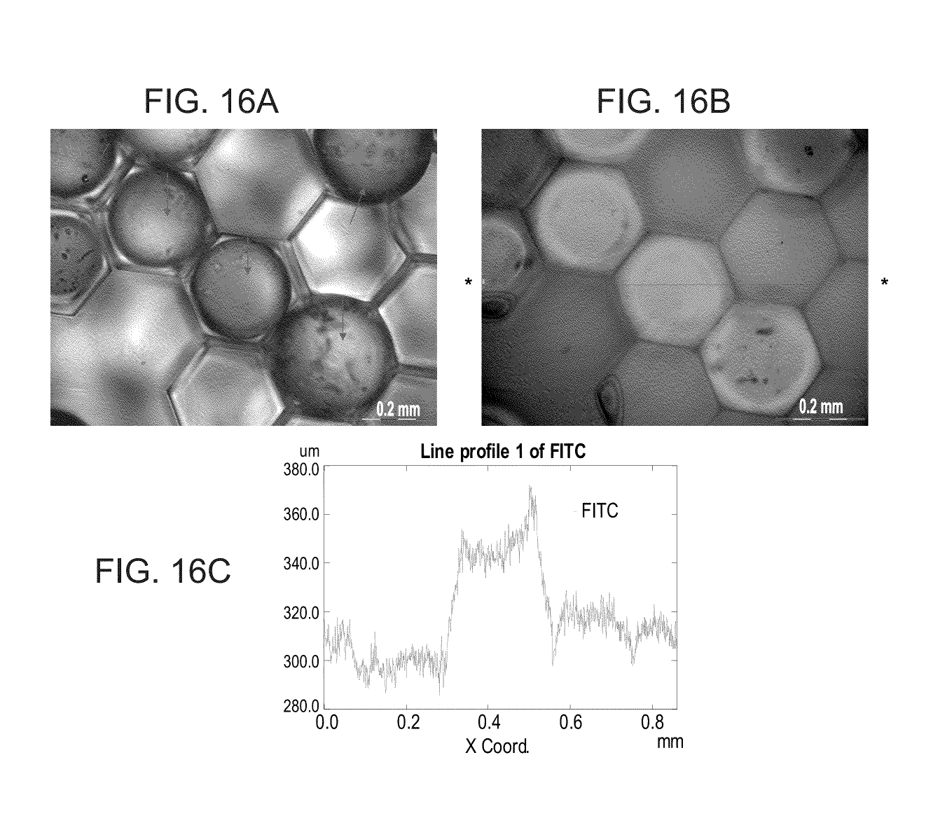

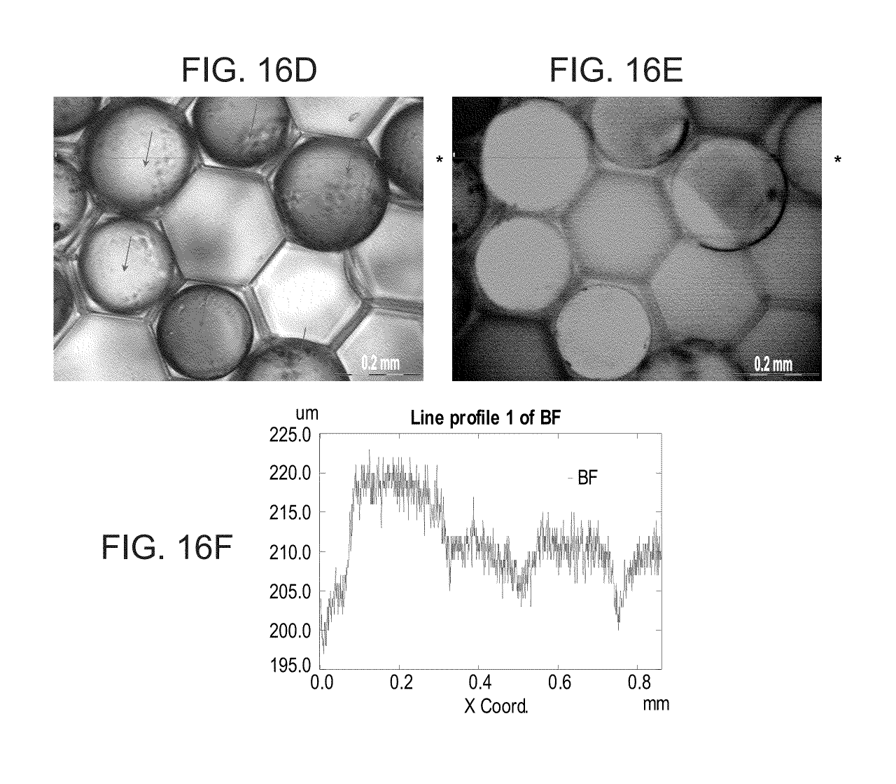

FIGS. 16A and 16D are bright field images of the beads plugging the chambers of the array, taken from different locations on the array, useful in practicing some embodiments of the invention. Beads are pointed to by arrows.

FIGS. 16B and 16E are fluorescence images of FIGS. 16A and 16D, useful in practicing some embodiments of the invention.

FIG. 16C is a horizontal fluorescent intensity profile of FIG. 16B, along the line marked by asterisks ‘*’, useful in practicing some embodiments of the invention. FIG. 16F is a corresponding intensity profile of FIG. 16E.

Results: FIGS. 16C and/or 16F illustrate a relative increase in the fluorescence intensity profile that corresponds to locations in which the chambers were plugged with beads, as compared to locations in which the chambers were not plugged.

The results provide support that objects can be arrested in chambers by using plugs to plug the opening of the chamber.

### Sperm Cryopreservation Experiment #1

An experiment was performed to cryopreserve and retrieve sperm cells using an array of hexagonal shaped, closely spaced chambers, in accordance with an exemplary embodiment of the invention.

Materials: FIG. 17A is a scanning electron microscope image of a hexagonal shaped, closely spaced array of chambers (e.g., similar to array 100 of FIG. 1B) used to perform the experiment. The chambers had a depth of 130 micrometers, and an opening size of 250 micrometers.

Methods: Experimental procedure was based on the method as illustrated in FIG. 1C. FIG. 17B is a light microscope image of sperm in the chamber (e.g., of FIG. 17A) before freezing, for example, after applying a solution containing sperm to the chambers, as in 150 of FIG. 1C.

The chamber array containing the sperm was cryopreserved and thawed using a standard crypreservation procotol such as in 160 of FIG. 1B, using the preservation device of FIGS. 6D and 6E. FIG. 17C is a light microscope image of sperm in the chamber of FIG. 17B, after thawing.

Results and conclusion: The experiment provides evidence that individual sperm can be successfully recovered from the hexagonal chamber array after cryopreservation and thawing, using the method of FIG. 1C. FIG. 17D is a light microscope image of individual sperm that were successfully recovered.

### Sperm Cryopreservation Experiment #2

An experiment was performed to cryopreserve and retrieve sperm cells using an array of spaced apart cylindrical (‘doughnut shaped’) chambers, in accordance with an exemplary embodiment of the invention.

Materials: The array of spaced apart cylindrical chambers as shown in FIGS. 8D-8I.

Methods: Experimental procedure was based on the method as illustrated in FIG. 5.

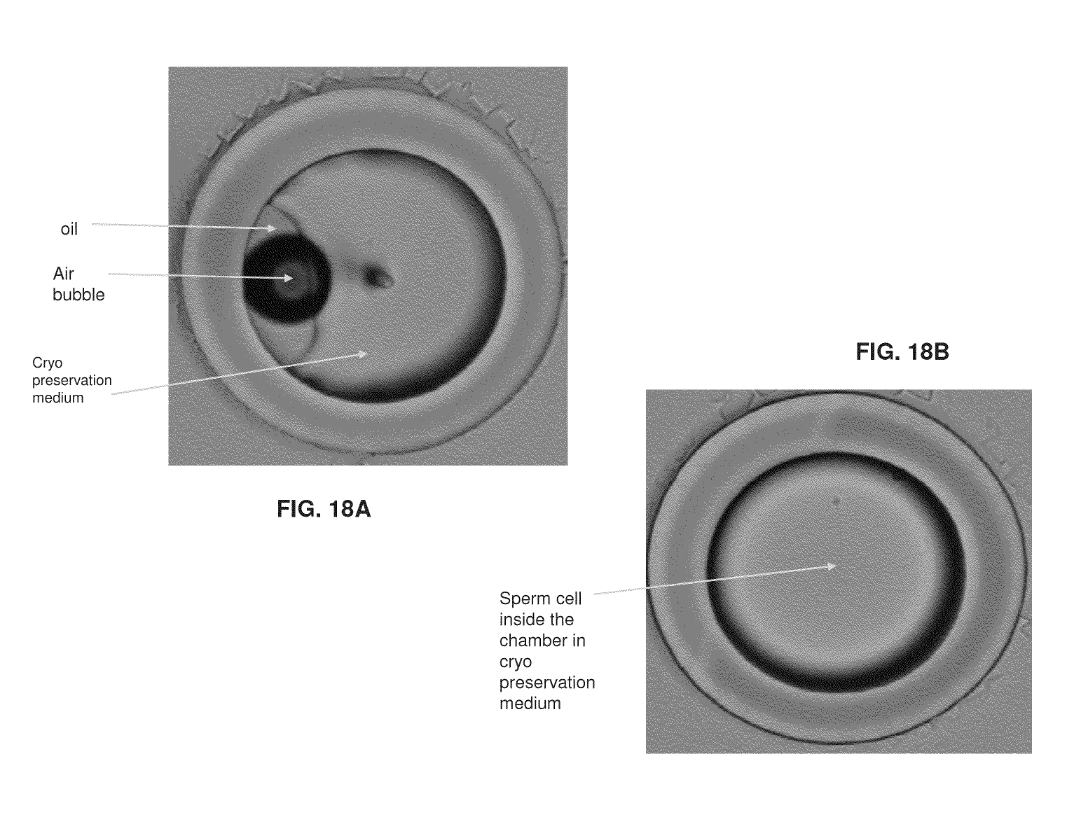

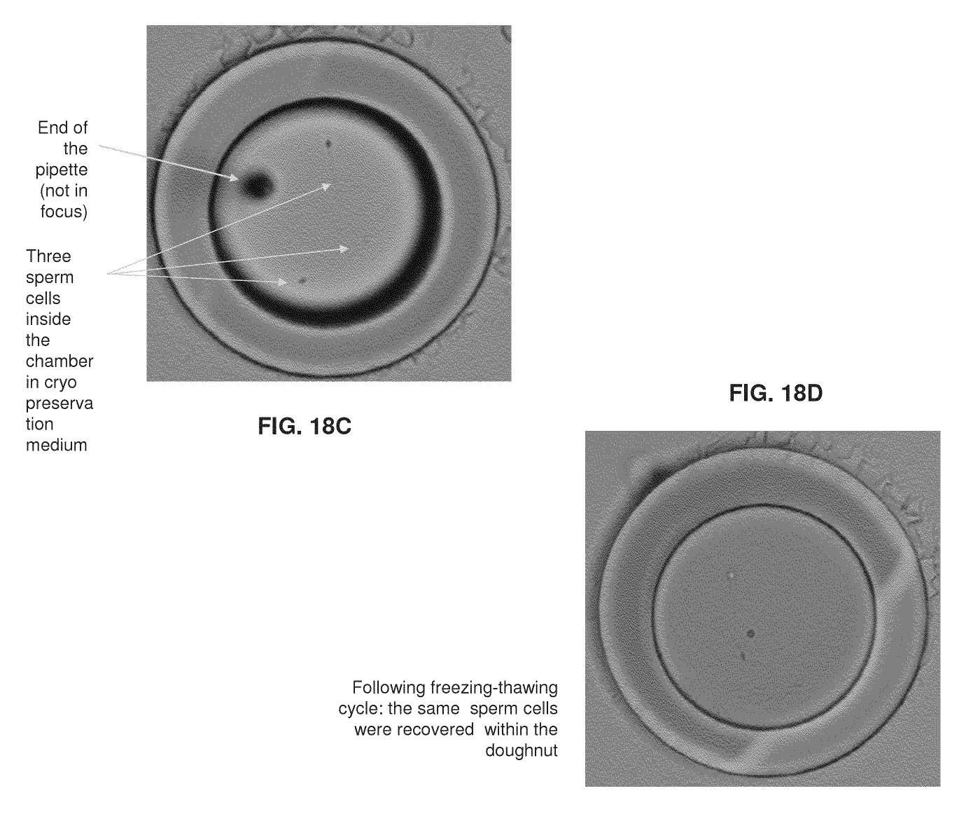

FIG. 18A is an image according to the method as in 504 (FIG. 5). Oil was applied to the chamber array trapping an air bubble inside. A pipette was inserted through the oil into the chamber, and a cryopreservative solution was injected to fill the chamber. The oil remained floating over the cryopreservative.

FIG. 18B is an image according to the method as in 506 (FIG. 5). Sperm cells were injected directly into the cryopreservative solution in the chamber by piercing the oil using a pipette. The oil floating on top of the cryopreservative solution trapped the sperm cells inside the chamber.

FIG. 18C is an image of another experiment, in which 3 sperm cells were injected into the chamber according to the method as in FIG. 504.

FIG. 18D is an image of the 3 sperm cells of FIG. 18C, after having undergone a cryopreservation and thawing cycle. The sperm were successfully revived and recovered.

Results and Conclusion: The experiments provide further evidence that sperm cells (avid swimmers) can be trapped inside chambers using the method of FIG. 5. The sperm cells inside the chamber can be successfully frozen and revived.

### Experiment: Forming A Liquid Array In ‘Doughnut’ Femtoliter Chambers

Inventors performed a series of experiments to illustrate arresting fluorescent solution inside an array of chambers on the order of femtoliters (fL), in accordance with an exemplary embodiment of a method and/or device of the invention. The use of fluorescent solution is meant to be non-limiting, and serves as an example to other objects in solution, such as molecular chemical reactions.

### Materials

‘Doughnut’ arrays, for example device 800 as described with reference to FIG. 8A, were fabricated by photo microlithorgraphy techniques. Each array type has about 1000 chambers. 3 different types of arrays were tested, having chamber dimensions of: volume 3.8 fL and height of 1.5 μm; volume of 2.3 fL and height of 1.15 μm; volume of 1.6 fL and height of 0.8 μm. The chambers are separated by a gap of about 5 μm.

The fl arrays were made from SU8-5 resist (a commonly used epoxy-based negative photoresist). The material is hydrophobic, and needs to be treated in order to become hydrophilic. Alternatively, the liquid can be forced inside the doughnuts by vacuuming.

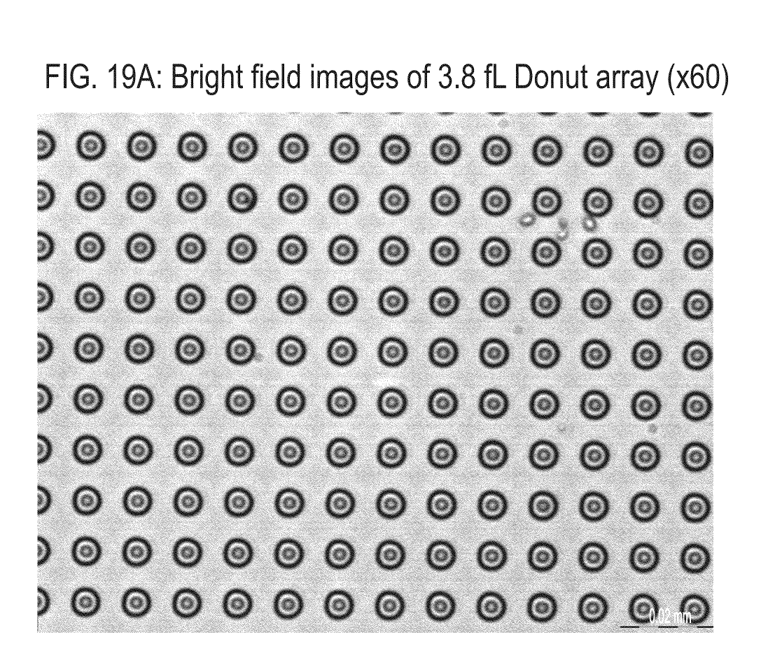

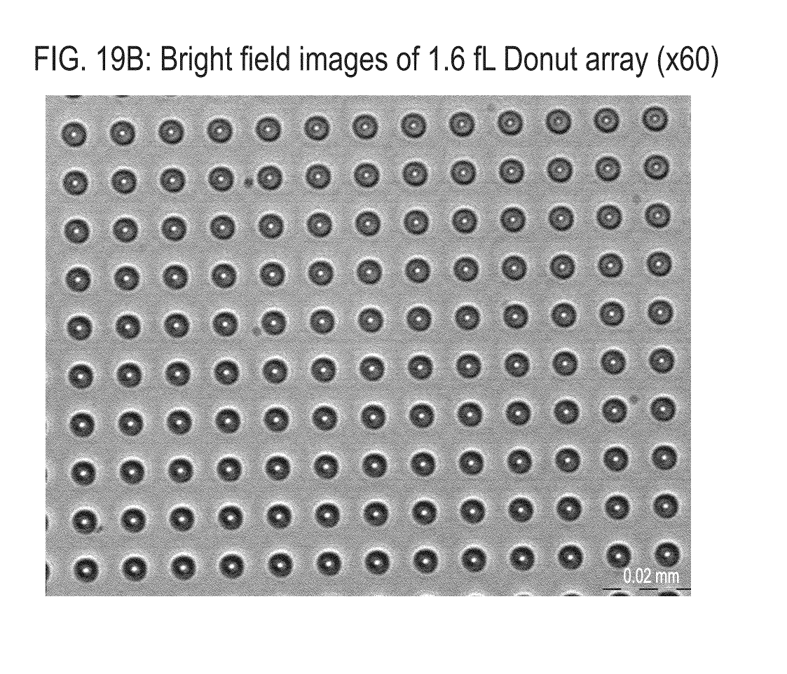

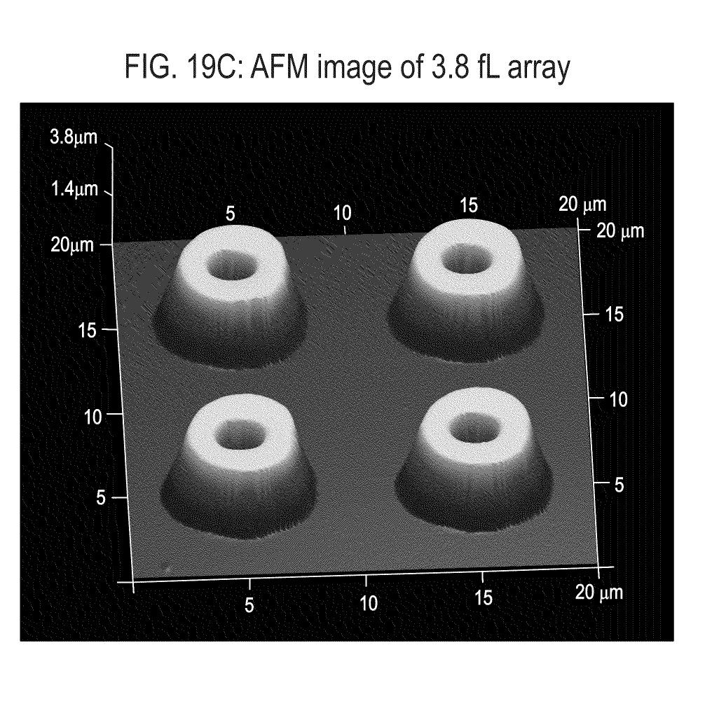

FIG. 19A is a bright field image of the 3.8 fL chamber array at a magnification of ×60. FIG. 19B is a bright field image of the 1.6 fL chamber array at a magnification of ×60.

FIG. 19C is an atomic force microscope (AFM) image of the 3.8 fL array.

### Method

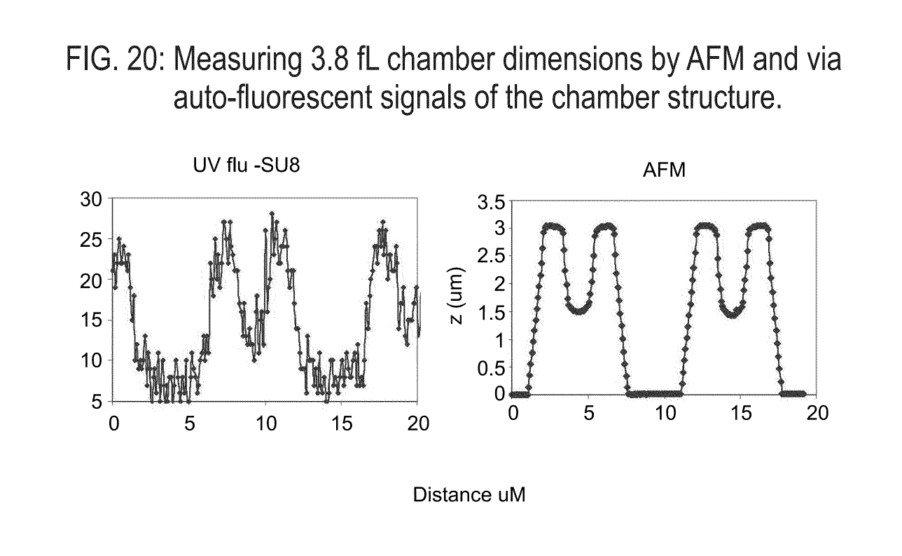

FIG. 20 compares measuring the 3.8 fL chamber dimensions by AFM (graph on right side of two chambers) to an intensity of auto-fluorescent signals of the chamber structure (graph on left side of two chambers). The chambers were empty of fluid. The auto-fluorescent signal is due to a property of the material used to manufacture the array. The comparison shows that measuring the intensity of the auto-fluorescent signals of the structure provide an estimate of the size and/or volume of the array.

Three fluorescent solutions of different concentrations were trapped in each of the three arrays (1.6 fL, 2.3 fL, 3.8 fL). Fluorecein concentration were 50 μM, 25 μM and 12.5 μM. Trapping occurred by manually applying a pliable piece of silicon over the array, for example, cushion plug 1232 as described with reference to FIG. 2G. Inventors hypothesize that the water repelling property of silicon forced out the solution from between the chambers, while the solution inside the chambers was arrested by the chamber. The silicon was kept in position. The silicone is transparent, but the samples were measured using an inverted microscope from the button, not through the silicon, so a non-transparent cover may also be utilized.

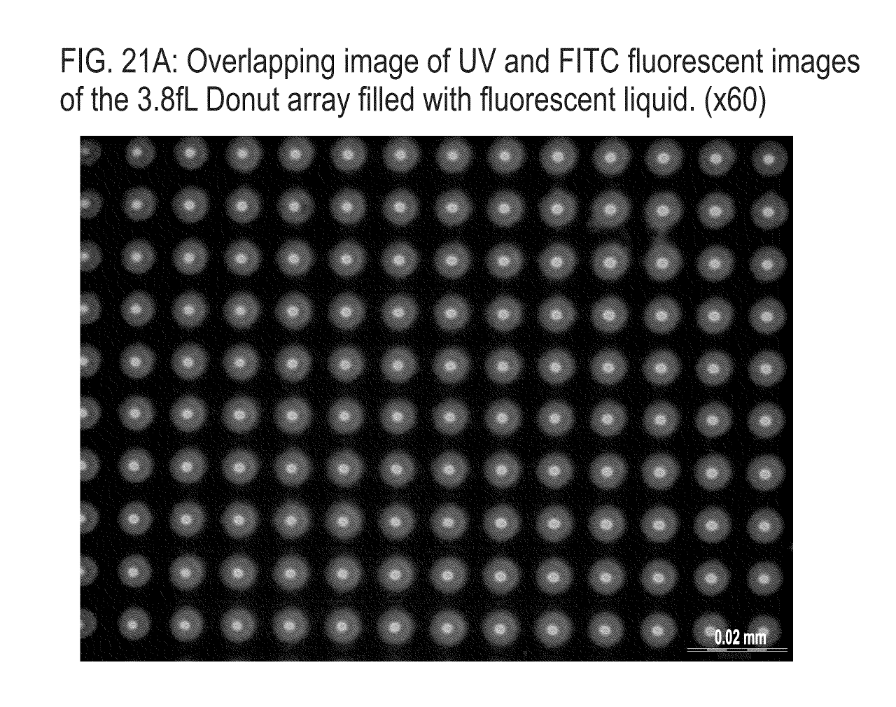

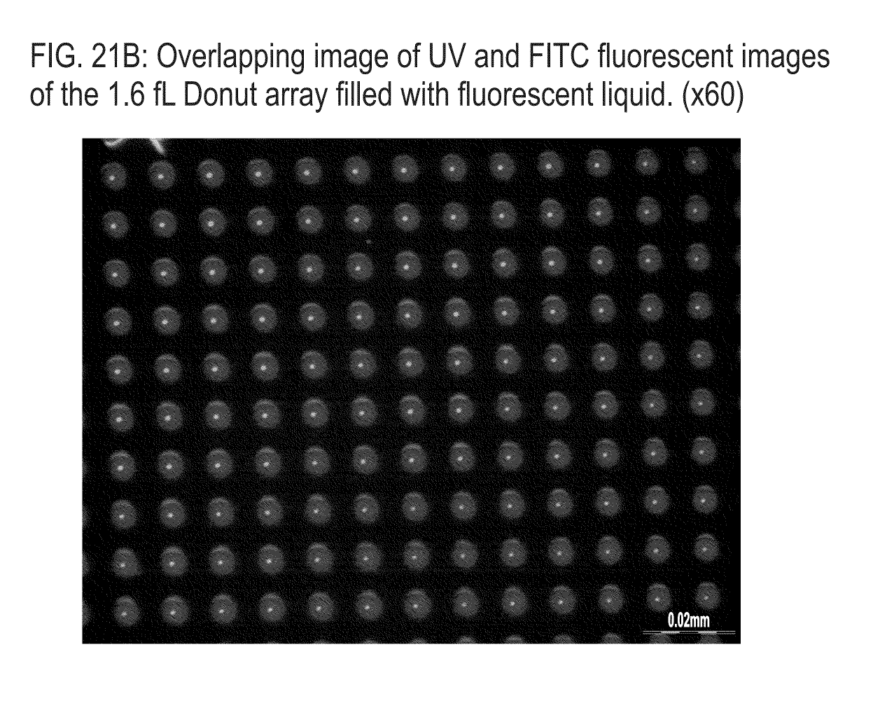

For each sample, fluorescent images were acquired. FIG. 21A is an overlapping image of UV and FITC fluorescent images of the 3.8 fL chamber array filled with a sample of the fluorescent liquid (at ×60 magnification). FIG. 21B is an overlapping image of UV and FITC fluorescent images of the 1.6 fL chamber array filled with fluorescent liquid (×60).

### Results

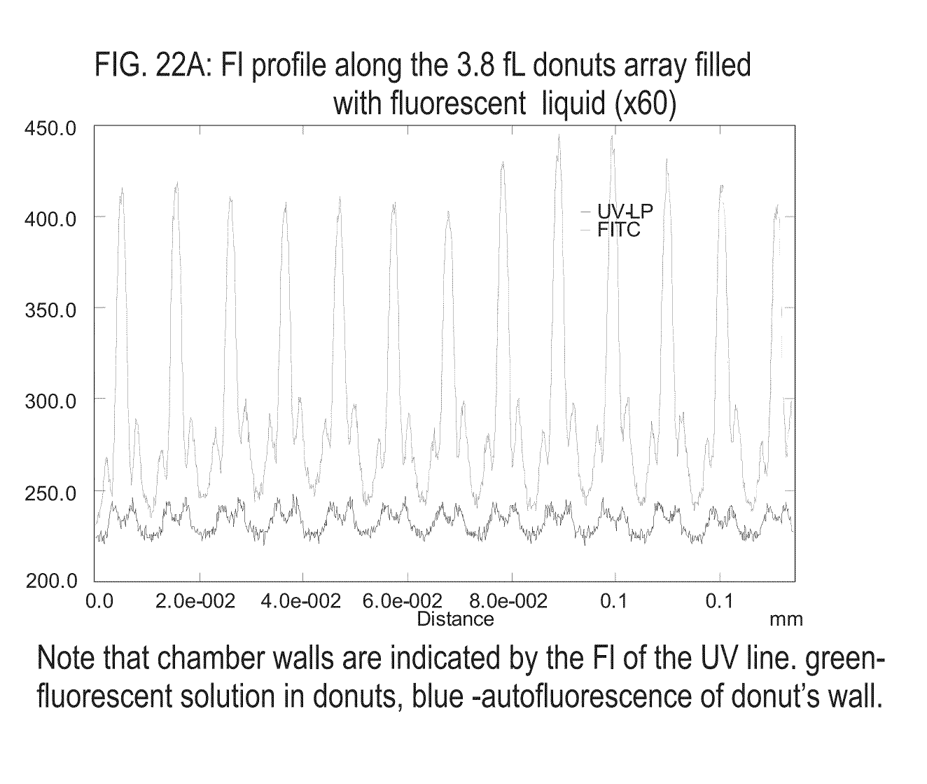

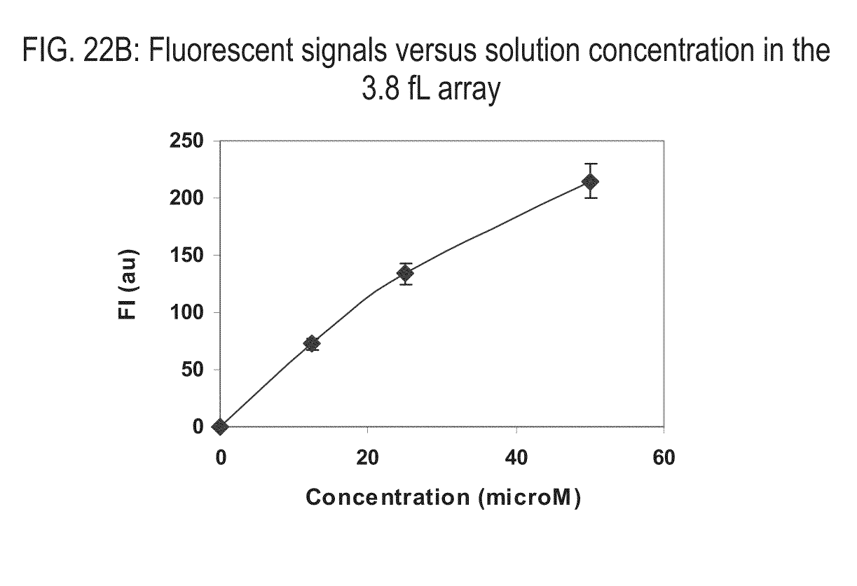

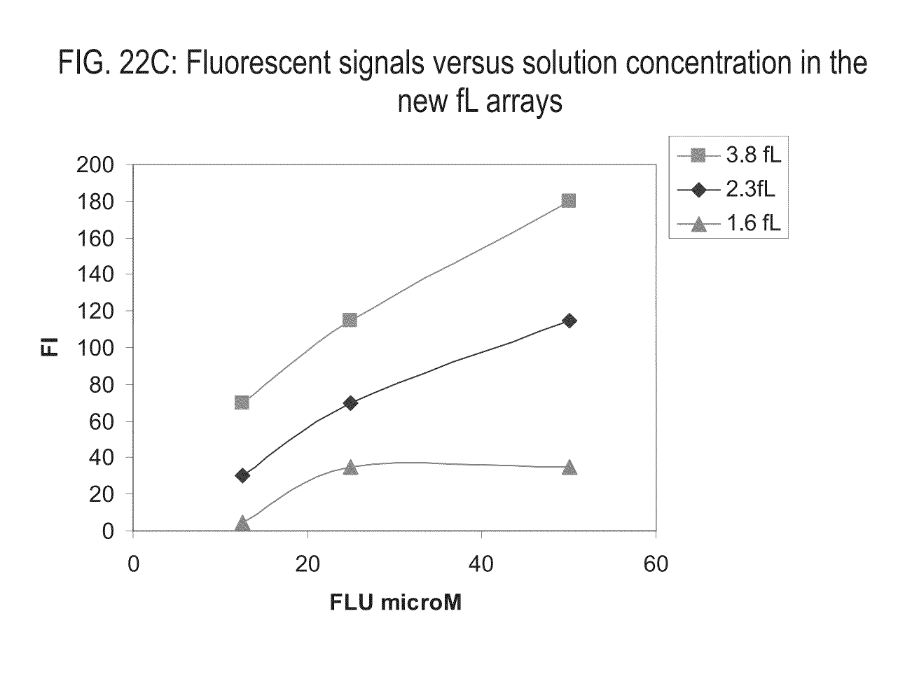

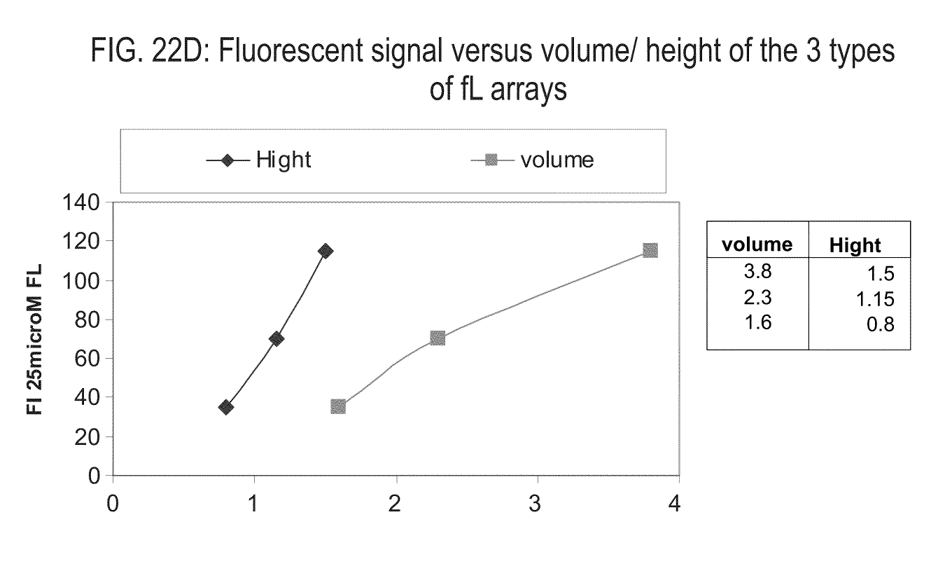

FIG. 22A is a graph of a fluorescent intensity (FI) profile along the 3.8 fL chamber array filled with the fluorescent liquid, after the application of the silicon gasket. The blue line illustrates the autofluorescence of the chamber walls (as verified by the description related to FIG. 20). The green line illustrates the fluorescent solution. The graph shows that the peak intensity of the solution (green) lies inside the chamber, between the walls (blue). The amount of solution outside of the chambers is negligible, as illustrated by the low intensity levels. The results provide support that a solution can be arrested inside chambers having volume on the order of femtoliters.

FIG. 22B is a graph of the amplitude of the fluorescent signals at different solution concentrations in the 3.8 fL array. The graph is substantially linear, suggesting that the chambers were filled with an approximately equal amount of solution during each experiment. The results provide support that the chambers can be filled with a repeatable amount of an arrested solution.

FIG. 22C is a graph of the amplitude of the fluorescent signals at different solution concentrations for the three fL arrays (3.8 fL, 2.3 fL, 1.6 fL). FIG. 22D is a graph of the intensity of the fluorescent signal as a function of volume or height of the 3 types of fL arrays, for a solution concentration of 25 microMol. Based on the assumption that the fluorescent intensity is linearly related to the depth of the chamber (as described above), the graph shows that the chambers can be repeatedly filled with approximately the same volume of fluid, and that the fluid is arrested in the respective chambers.

### Conclusion

The results of the experiments provide support that the methods described herein of arresting objects in chambers work (even) for chambers having volumes on the order of femtoliters. Inventors believe that the results are non-limiting, that other methods as described herein can be used to arrest solution in chambers, and that the methods described also work for chambers of sizes outside of the tested range.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of arresting objects in an array of chambers comprising:
applying a solution to at least one chamber in an array of chambers, in a manner that isolates said at least one chamber, such that at least one object in said solution is arrested in said at least one chamber; and
substantially sealing said at least one chamber against escape of said objects by a liquid or a film or a gel cover for said at least one chamber, or by a plug.

2. A method as in claim 1, wherein said solution is applied to two chambers, then said at least one chamber is isolated by reducing an amount of said solution in and/or around said chambers.

3. A method as in claim 1, wherein said solution is applied to said at least one chamber to a level no more than a height of walls of said at least one chamber.

4. (canceled)

5. A method as in claim 1, wherein said cover comprises a fluid floating above said solution.

6. A method as in claim 1, wherein said cover repels water from said chambers.

7. A method as in claim 1, wherein said cover is a liquid, and further comprising inserting said solution including said at least one object into said at least one chamber through said cover.

8-9. (canceled)

10. A method as in claim 2, wherein the amount of said solution is reduced by wicking.

11. A method as in claim 1, wherein said at least one object comprises a living cell or a molecule.

12. A method as in claim 1, wherein said at least one object comprises a sperm cell or a DNA molecule.

13-14. (canceled)

15. A method as in claim 1, further including cryopreserving said arrested objects in said chambers.

16. (canceled)

17. A system according to claim 22, wherein said chambers are separated by a space that is large enough to prevent and/or reduce surface tension forces from holding a fluid in said space.

18. A system according to claim 22, wherein a volume of said chamber ranges from an attoliter to a milliliter.

19. A system according to claim 22, further comprising a material to wick an excess of a solution over and/or around said chambers.

20. A system according to claim 22, wherein said supporting base is made of a material having a sufficiently low heat capacity and a sufficiently high thermal conductivity to cryopreserve cells in said chambers.

21. (canceled)

22. A system for arresting objects in an array of chambers comprising:
a supporting base;
a plurality of chambers on said base, each chamber having an opening; and
a cover for at least some of said chambers that substantially prevents escape of said objects,
wherein said cover is comprised of a liquid layer over at least some of the chamber openings, or a gel cover, or a films or plugs shaped to conform to said openings that substantially close said openings without substantially entering said chamber or by sinking into said openings,
wherein said chambers are configured to receive a solution therein including said objects.

23. (canceled)

24. A system according to claim 22, wherein said plug includes a magnetic material and further comprising a magnet positioned relative to at least one chamber to attract said plug to said chamber opening.

25. A system according to claim 22, wherein said plug is coated with a first substance, and said opening of at least one chamber is coated with a second substance having an affinity for said first substance.

26-36. (canceled)

37. A system according to claim 22, wherein said chambers are separated from one another by a gap, said gap being defined as a space surrounding at least some portion of a height of walls of said chambers above said support that isolates fluid in one chamber from fluid the other chambers.

38. A system according to claim 22, wherein said chambers are cylinders having said opening at an upper end thereof.

39. A system according to claim 22, wherein at least portions of inner surfaces of said chambers are made from or coated with a hydrophobic coating.

40. A system according to claim 22, further comprising one or more elevations in said support of said chamber, said elevations arranged to prevent a suspension from contacting walls of said chambers.

41-43. (canceled)

44. A method according to claim 15, further comprising selecting said chamber according to a desired freezing speed.

45. A method according to claim 1, wherein said chambers
are sized to receive objects having a diameter of up to 400 μm.

46. A method according to claim 1, wherein said fluid is inserted into said at least one chamber before insertion of said object and said object is then inserted through said cover into said fluid.

47. A system according to claim 22, wherein said chambers are separated on said support by an air gap that isolates fluid in one chamber from fluid the other chambers.
